(19) United States
(12) Patent Application Publication
(10) Pub. No.: US 2026/0320660 A1
(43) Pub. Date: Oct. 15, 2026

(54) DIGITAL CATALOG USER INTERFACE AND MODULAR CATALOG ARCHITECTURE

(71) Applicant: Block, Inc., Oakland, CA (US)

(72) Inventors: Elizabeth Kottkamp, San Mateo, CA (US); Ji Zhao, Sunnyvale, CA (US); Alexander Walter Smith, San Francisco, CA (US); Scott Sheldon Buchanan, Crosswicks, NJ (US)

(73) Assignee: Block, Inc., Oakland, CA (US)

(21) Appl. No.: 19/178,598

(22) Filed: Apr. 14, 2025

(51) Int. Cl. G06Q 30/0601

(52) U.S. Cl. CPC G06Q 30/0601

(57) ABSTRACT

Digital catalog user interface and a modular catalog architecture are described. In one or more examples, a catalog management system receives a request to create an item and displays an initial item creation interface with a field for designating an item type. Upon receiving user input designating an item type, the catalog management system retrieves a catalog schema associated with the designated type. A customized item creation interface is dynamically generated based on the schema, including input fields corresponding to attributes defined by the schema and user interface elements for specifying sales channels. The catalog management system displays the customized interface and receives user input specifying attribute values and selecting channels. The customized interface is dynamically updated to display additional input fields based on the selected channel. An item entry is generated in the digital catalog based on the received user input and stored in association with the catalog.

### TECHNICAL FIELD

A variety of techniques have been developed to support digital catalogs of products or services. Conventional techniques to do so, however, may become overwhelmed by variations and diversity of types of products or services being offered in the digital catalogs, especially as part of implementation of large platforms.

Technical challenges caused by the overwhelming number of variations reduces accuracy as users may be unaware of available functionalities, causes inefficient use in computational resources used to support unused or irrelevant functionalities, and rely on specialized knowledge that limits user accessibility to these techniques.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is a block diagram depicting a non-limiting example of a system configured to implement a modular catalog architecture and digital catalog user interface in accordance with one or more implementations.

FIG. 2 depicts a system in an example implementation showing operation of a catalog management system of FIG. 1 in greater detail as generating a modular catalog architecture of a plurality of catalog modules in accordance with one or more implementations.

FIG. 3 depicts a system in an example implementation of a client device output of an intake user interface usable to guide creation of a catalog module by a catalog intake system of FIG. 2 in accordance with one or more implementations.

FIG. 4 is a flow diagram depicting a step-by-step procedure in an example implementation of operations performable by a processing device for accomplishing a result of catalog module generation for inclusion as part of a modular catalog architecture in accordance with one or more implementations.

FIG. 5 depicts a system in an example implementation showing operation of a catalog management system of FIG. 1 as generating a digital catalog using one or more catalog modules selected from a modular catalog architecture of FIG. 2 in accordance with one or more implementations.

FIG. 6 is a flow diagram depicting a step-by-step procedure in an example implementation of operations performable by a processing device for accomplishing a result of item description generation and digital catalog generation using catalog modules of a modular catalog architecture of FIG. 2 in accordance with one or more implementations.

FIG. 7 depicts an example implementation of an item creation user interface of FIG. 5 configured as an item sheet in accordance with one or more implementations.

FIG. 8 depicts an example implementation of an item creation user interface of FIG. 5 configured to select from a plurality of default options responsive to selection of a create item option of FIG. 7 in accordance with one or more implementations.

FIG. 9 depicts an example implementation of an item creation user interface of FIG. 5 configured to create an item as employing a read-only state in accordance with one or more implementations.

FIG. 10 depicts an example implementation of an item creation user interface of FIG. 5 configured to leverage verticals in accordance with one or more implementations.

FIG. 11 depicts an example implementation of an item creation user interface of FIG. 5 configured to leverage channels in accordance with one or more implementations.

FIG. 12 depicts an example implementation of the item creation user interface of FIG. 5 configured to leverage collections in accordance with one or more implementations.

FIG. 13A is a flow diagram depicting a step-by-step procedure in an example implementation of operations performable by a processing device for accomplishing a result of digital catalog generation using catalog modules selected from a modular catalog architecture in accordance with one or more implementations.

FIG. 13B is a flow diagram depicting a step-by-step procedure in an example implementation of operations performable by a processing device for accomplishing a result of user interface element control and filtering based on relevant to user input data.

FIG. 14 is a non-limiting example illustrating an environment in which recommendation techniques described herein are performed in accordance with one or more implementations.

FIG. 15 is a non-limiting example illustrating an environment in which recommendation techniques described herein are performed in accordance with one or more implementations.

FIG. 16 is a non-limiting example illustrating an environment in which recommendation techniques described herein are performed in accordance with one or more implementations.

### DETAILED DESCRIPTION

The disclosed method introduces a dynamic item creation interface for seller catalog systems, where user interface (UI) elements are selectively revealed based on real-time contextual cues. Rather than exposing all catalog configuration options upfront—which often results in cognitive overload and friction, the disclosed system employs a progressive reveal framework. This framework personalizes the item creation experience by inferring seller intent and vertical relevance from early user input, such as item name or type, and dynamically tailoring the interface accordingly.

Conventional techniques for generating digital catalogs often struggle with item diversity and complexity of products and services being offered in the digital catalogs. For instance, a digital service provider (DSP) system may offer physical goods such as clothing with multiple size and color variations, digital products such as e-books or software licenses, and online services, e.g., consultations or classes. Each of these item types therefore may involve a different set of attributes and functionalities within a digital catalog. As a result, the overwhelming number of variations and options may lead to an overpopulated user interface that presents an excessive number of fields, many of which may be irrelevant to a specific item being added. This complexity can significantly reduce accuracy in item entry, as fields may be overlooked or incorrectly input due to confusion or fatigue.

The abundance of functionalities in conventional catalog systems may also lead to inefficient use of computational resources. For example, a conventional digital catalog system designed to handle complex inventory management for physical goods may wrongly allocate resources to maintain these features for digital products or services that do not involve stock tracking. Similarly, features for managing recurring subscriptions or appointment bookings may be irrelevant for merchants who solely sell physical goods or services. These inefficiencies often result in decreased system performance, increased server load, and higher operational costs for both a digital service platform (DPS) system and users of the system in real-world scenarios.

Moreover, conventional catalog generation techniques often rely on specialized knowledge, limiting general user accessibility. A conventional digital catalog system, for instance, may involve specialized knowledge by a user to understand complex categorization hierarchies, SKU generation rules, specific terminology related to particular platforms, and so forth. This reliance on specialized knowledge may create barriers for entities that do not have access to this knowledge, either by the entity itself or an ability to hire someone that does. Examples of entities lacking this knowledge include small business owners and new merchants who may not have extensive technical expertise or familiarity with catalog management best practices or do not have the resources to employ staff that has this expertise.

As a result, technical impediments exist in fully utilizing functionalities supported by these conventional digital catalog systems, thereby leading to suboptimal catalog organization, incomplete item listings, and errors in fields such as pricing or inventory levels. These technical limitations may impact an ability to effectively showcase and sell products or services described in the digital catalog across various channels, e.g., email, instant messaging, physical mail, a webpage, and so on.

Accordingly, to address these and other technical challenges a digital catalog user interface and modular catalog architecture are described. In one or more examples, the modular catalog architecture is formed from a plurality of catalog modules that are configurable to output modular user interfaces. The user interface elements are filtered and rendered in response to seller-specific signals, such as a seller's vertical, catalog complexity, or selected sales channels. For instance, an apparel merchant creating a “T-shirt” may trigger the display of size and color variation controls, inventory tracking options, and gendered item attributes, while a food seller inputting a “Bruschetta” item would instead surface modifiers, allergen information, and calorie fields. These differences may be soft-coded and driven by a flexible metadata layer connected to “Item Types,” which allows vertical-specific UI logic to be cleanly expressed and customized without interfering with other seller experiences.

The use of the modular catalog architecture offers significant technical advantages for catalog management systems and address the technical challenges of conventional techniques. To do so, the modular catalog architecture supports implementation of a flexible, user-centric, and scalable system that is adaptable to diverse item types as further described below.

By forming the modular catalog architecture using a plurality of catalog modules having modular user interfaces, for instance, the catalog management system is configurable to dynamically assemble user interfaces tailored to specific tasks, e.g., for particular item categories. This modularity enables the catalog management system to present relevant information and functionalities to users and reduce cognitive load and improve an overall user experience. Modularity of the modular catalog architecture also reduces computational resource usage by providing functionalities that are relevant to a specific context and restricting execution of those functionalities that are irrelevant, which is not possible in conventional techniques. The modular catalog architecture adapts to a merchant's context by downplaying rarely used attributes, defaulting non-critical fields to a collapsed or read-only state, and prioritizing attributes that are most relevant to that seller's operational reality. This selective emphasis extends to how items are merchandised across channels, using sections like “Where it's sold” to highlight attributes important for in-store, online, or third-party fulfillment contexts. By treating the interface as a responsive surface that adjusts to the seller's intent and complexity, the system achieves both a simplified entry point for fast item creation and a sophisticated toolset for more advanced catalog structuring—all within the same unified experience.

The catalog management system, in one or more examples, is configured to generate the catalog modules, automatically and without user intervention. To do so, the catalog management system is configurable to generate the catalog modules based on item descriptions from a digital catalog and determining user interface elements, which are then used to form a catalog schema. This process includes analyzing existing item entries to identify common attributes, input fields, and optional features across different item types based on the item descriptions. In one or more examples, the catalog management system leverages rule-based techniques, machine learning, and/or other pattern recognition techniques to categorize items and extract relevant characteristics. These insights are then used to construct a catalog schema that defines a structure and relationships of various item attributes. The catalog schema, once formed, then serves as a blueprint for the catalog management system in generating executable catalog modules, ensuring that each catalog module contains relevant user interface elements to capture and display an item description accurately and comprehensively.

To do so, the catalog management system analyzes existing item listings, from electronics to fashion to home goods. Using machine learning, rule based, or heuristic techniques, the catalog management system identifies that electronic devices consistently have a particular set of attributes (e.g., brand, model number, and technical specifications) while clothing items typically include another set of attributes, e.g., size, color, and material. For home goods, the catalog management system may recognize common fields such as dimensions, weight, and care instructions. The catalog management system may also detect that some merchants frequently add custom fields like “energy efficiency rating” for appliances or “age group” for toys from past usage data.

Based on this analysis, the catalog management system is configurable to construct a flexible catalog schema that accommodates these diverse item types and corresponding attributes. Therefore, when a new merchant joins the digital service provider (DSP) system to list a smartphone, the catalog management system identifies a catalog module that is generated as specifically tailored for electronics. This catalog module is executable in this example to present a modular user interface having fields for brand, model, storage capacity, camera specifications, and other relevant attributes, while omitting irrelevant fields such as clothing sizes or furniture dimensions. This tailored approach ensures that support is provided to input a comprehensive and accurate item description efficiently, improving item listing quality and enhancing an overall user experience. Elaborating on listing quality and overall user experience, for instance, generation of the digital catalog is in service of getting items ready to sell on the channels (e.g., POS, Online, third-party marketplaces, etc.) that the seller cares about, especially online where there is no human to facilitate the sale to the customer.

Use of dedicated catalog modules to output customizable modular user interfaces for corresponding tasks in generating an item description offers several technical advantages. By presenting relevant interface elements for a specific item type or task, the catalog management system conserves computational resources that are otherwise wasted on rendering and maintaining unused UI components. This targeted approach also improves operational efficiency by reducing server load and minimizing data transfer between a client device and a server implementing the catalog management system. Additionally, the modular user interface is configurable to increase user awareness of available functionalities by prominently displaying relevant features and options within the context of a current task. This contextual presentation guides user discovery of technical capabilities of the catalog management system with increased efficiency over that of conventional techniques and leads to increased accuracy and completeness in the item descriptions.

The modular catalog architecture also facilitates increased efficiency in maintenance and generating updates to the catalog management system. New item types or attributes, for instance, may be incorporated by creating additional catalog modules without disrupting an existing system structure. This extensibility allows the catalog management system to evolve and adapt to changing functional criteria and emerging product categories with minimal development effort. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Modular Catalog Architecture Environment

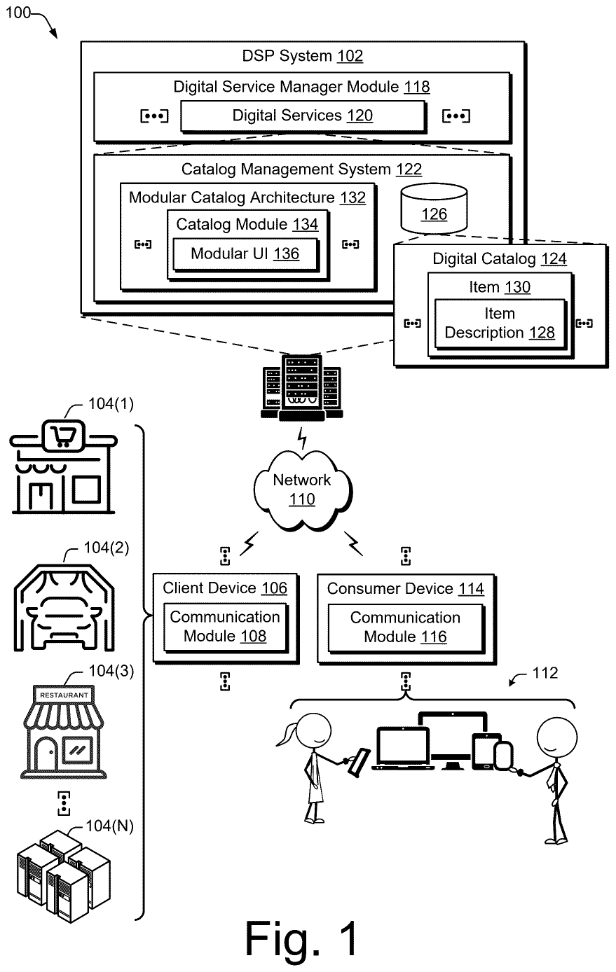

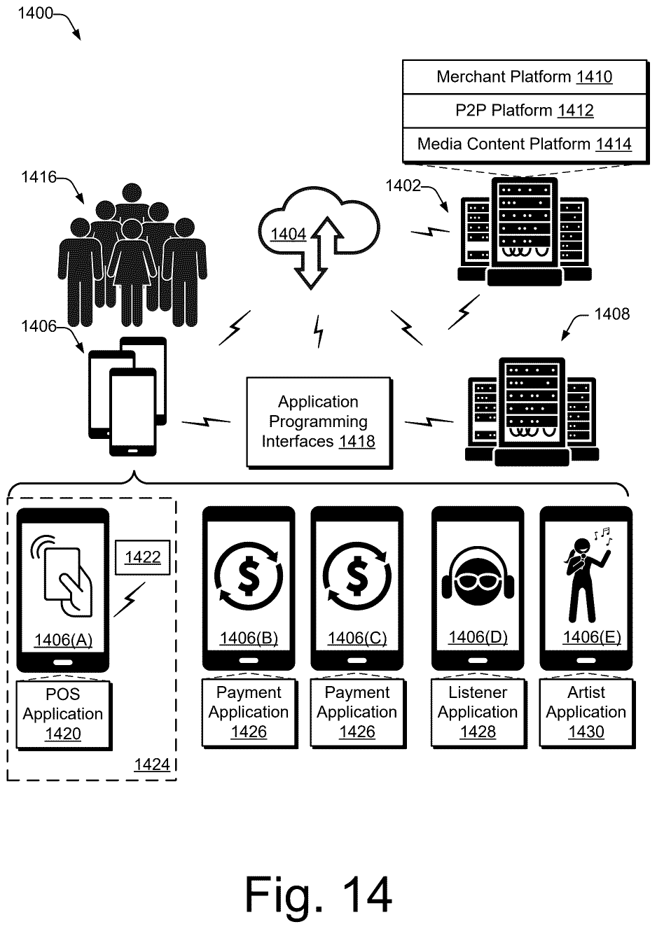

FIG. 1 is a block diagram depicting a non-limiting example of a system 100 configured to implement a modular catalog architecture and digital catalog user interface in accordance with one or more implementations. The system 100 includes a digital service provider (DSP) system (illustrated as a DSP system 102) as communicatively coupled with a plurality of establishments that are configured to provide one or more products or services, examples of which include a vehicle establishment 104(1), a retail establishment 104(2), a restaurant establishment 104(3), . . . , to an online platform 104(N). The establishments 104 are communicatively coupled to the DSP system 102 via a network 110, e.g., the internet. The various establishments 104 may be configured as merchants as further described in relation to FIGS. 14-16.

Each of the establishments 104 may employ one or more client devices having respective communication modules, an example of which is illustrated as client device 106 having communication module 108 that is communicatively coupled to a network 110. Entities 112 that are to consume items (e.g., products or services) of the respective establishments (e.g., purchase items from the DSP system 102) are illustrated as leveraging a respective consumer device 114 having a communication module 116 that supports communication over the network 110, e.g., to the DSP system 102.

Computing devices that implement the DSP system 102, the client device 106, and the consumer device 114 are configurable in a variety of ways. Examples of computing device configurations include a server, a desktop computer, a laptop computer, a mobile device (e.g., assuming a handheld configuration such as a tablet or mobile phone), an IoT device, a wearable device (e.g., a smart watch), an augmented reality/virtual reality device, and so forth. For the DSP system 102, for instance, clusters of graphics processing units (GPUs) are also contemplated, e.g., to accelerate implementation of artificial intelligence (AI) or other functionality.

Thus, a computing device ranges from full resource devices with substantial memory and processor resources to low-resource devices with limited memory and/or processing resources. Although in instances in the following discussion reference is made to a computing device in the singular, a computing device may also represent any number of different computing devices, such as multiple servers of a server farm utilized to perform operations “over the cloud,” e.g., as part of a media content platform implemented by the DSP system 102.

In the illustrated example, the DSP system 102 includes a digital service manager module 118 that implements one or more digital services 120 using hardware and software resources, e.g., a processing device and computer-readable storage medium that is non-transitory. Digital services 120 are made available, remotely, via the network 110 to computing devices, e.g., client device 106 and consumer device 114. Digital services 120 are scalable through implementation by the hardware and software resources and support a variety of functionalities, including accessibility, verification, real-time processing, analytics, load balancing, and so forth. Examples of digital services 120 include a social media service, streaming service, payment service, digital content repository service, content collaboration service, and so on as further described in relation to FIGS. 14-16.

In the illustrated example, the digital services 120 are utilized to implement a catalog management system 122. The catalog management system 122 is configurable, in one or more examples, to generate a digital catalog 124, maintain the digital catalog 124 (e.g., in a storage device 126), and control access to the digital catalog 124, e.g., by the client device 106 and/or the consumer device 114.

The digital catalog 124 includes one or more item descriptions 128 for a plurality of items 130 that are representative of products (i.e., goods) or services described by the digital catalog 124, e.g., are available for purchase, download, pickup, and so forth. A digital catalog 124 may describe a wide variety of items 130, including both physical goods and services as well as digital goods and services. For physical goods, for instance, the digital catalog 124 is configurable to include item descriptions 128 of clothing items (e.g., a leather jacket with item descriptions 128 on size, color, material, and care instructions), electronics (e.g., with item descriptions 128 for screen size, processor, camera resolution, and battery life), home appliances (e.g., with item descriptions 128 on capacity, energy efficiency rating, and special features), and so forth. Physical services described using the item descriptions 128 may include examples such as car repair appointments with options for different service types, estimated duration, and pricing.

For digital goods, the digital catalog 124 may feature e-books with item descriptions 128 providing details on page count, genre, and file format compatibility, software applications with item descriptions 128 on system configurations, key features, and licensing terms, digital art prints with item descriptions 128 detailing resolution specifications and download instructions, and so forth. Examples of item descriptions 128 of digital services include online language courses with descriptions of proficiency levels, lesson formats, and instructor qualifications, cloud storage plans having item descriptions 128 of details on storage capacity, file sharing capabilities, and security features, or virtual personal training sessions with item descriptions 128 providing information on session duration, equipment to be used, and trainer expertise. Each of these diverse items 130 are representable in the digital catalog 124 using the item descriptions 128 as providing comprehensive descriptions tailored to specific attributes of the items 130.

Conventional techniques in support of digital catalogs in many real world scenarios, however, have become overwhelmed by variations and diversity of types of products or services being offered in the digital catalogs, especially in scenarios involving millions of items being offered via a platform to potentially billions of entities 112. This complexity can lead to processing inefficiencies as computational resources are allocated to maintain features that may be irrelevant for certain item types. For example, inventory management features designed for physical goods may be irrelevant to digital products or services.

Additionally, users often struggle to navigate conventional catalog user interfaces that present an excessive number of fields or options, many of which may be irrelevant to the specific item being managed. These technical challenges can result in reduced accuracy as users may overlook desirable fields or be unaware of available functionalities. Furthermore, these conventional systems often rely on specialized knowledge, creating barriers for users who lack extensive technical expertise or familiarity with complex catalog management practices.

Accordingly, to address these and other technical challenges the catalog management system 122 is configured in one or more examples to implement a modular catalog architecture 132 leveraging a plurality of catalog modules 134 that are configurable to output respective module user interfaces, illustrated as modular UI 136 in FIG. 1.

In one implementation, the item creation workflows are structured, moving from a static, one-size-fits-all interface to a responsive structure that progressively reveals relevant UI elements based on seller input. Rather than presenting merchants with a monolithic item sheet filled with irrelevant fields, the system begins by asking context-defining questions—such as “What is the item?” “Where is it sold?” and “How is it fulfilled at location X?” and then dynamically tailors subsequent UI components based on those answers. For example, selecting “physical good” as an item type triggers downstream fields focused on stock tracking and variant configuration, while “prepared food and beverage” would surface fields for nutritional information and channel-specific pricing like happy hour rates. Similarly, a “service” type may present dynamic pricing logic and fulfillment options unique to booking-based businesses. These questions may be even further customized based on the specifics of the seller, e.g., for an ice cream shop with freezer needs versus a candy shop with storage needs.

In one implementation, advanced behaviors, such as conditional visibility of settings based on fulfillment method (e.g., online-only items triggering preorder or gift options), are configurable. Further, variants may be handled such that once a variant dimension is selected, a matrix interface appears for configuring variant-specific pricing and inventory, automatically generating structured item pages from those inputs. In some examples, AI-driven item classification from uploaded images are configurable, e.g., to introduce seller-customizable layouts—allowing merchants to choose which sections appear by default or reorder attributes to suit their workflow.

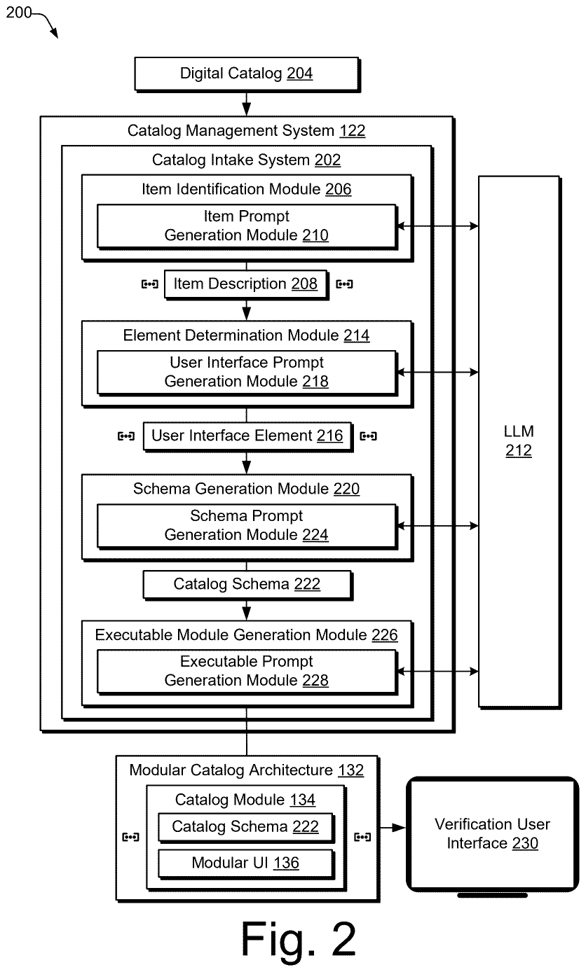

The catalog management system 122, in one or more examples, is configured to generate the catalog modules 134 based on item descriptions from a digital catalog to determine user interface elements that form a catalog schema. This process involves analyzing existing item entries to identify common attributes, input fields, and optional features across different item types. To do so, the catalog management system 122 may leverage machine learning and other pattern recognition techniques to categorize items and extract relevant characteristics. These insights are then used to construct a catalog schema that defines the structure and relationships of various item attributes. The catalog schema then serves as a blueprint for generating catalog modules 134 by the catalog management system 122, automatically and without user intervention, ensuring that each catalog module 134 contains relevant user interface elements to capture and display an item description accurately and comprehensively. Further discussion of catalog module generation by the catalog management system 122 may be found in relation to FIGS. 2-4.

The modular catalog architecture 132, through use of the catalog modules 134, supports implementation of a flexible and scalable system that is adaptable to diverse item types. The modular catalog architecture 132 supports implementation of a flexible and scalable system that is adaptable to diverse item types. This approach allows the catalog management system 122 to efficiently handle a wide range of products and services without becoming overwhelmed by inherent differences. By utilizing distinct catalog modules 134 for respective item categories, for instance, the catalog management system 122 can dynamically adjust a user interface and functionality to suit the specific criteria of each item type.

For example, a commerce platform may implement the modular catalog architecture 132 to support sellers across various industries. When a clothing retailer uses the system to list a new jacket, for instance, the catalog management system 122 activates a catalog module 134 specifically designed for apparel. In this example, the plurality of catalog modules 134 are configured to present fields in the modular UI 136 that relevant to clothing, such as size options, fabric type, care instructions, and fit details. The modular UI 136 may also include specialized features like a size chart generator or a color variant tool.

In contrast, when a software developer interacts with the catalog management system 122 to list a new mobile app, the catalog management system 122 activates a different plurality of catalog modules 134 of the modular catalog architecture 132 that is tailored for digital products. The catalog module 134, for instance, is configurable to include fields for app version, compatibility criteria, feature lists, and in-app purchase options. The catalog module 134 may also incorporate functionality for uploading screenshots, linking demo videos, managing software updates, and so forth.

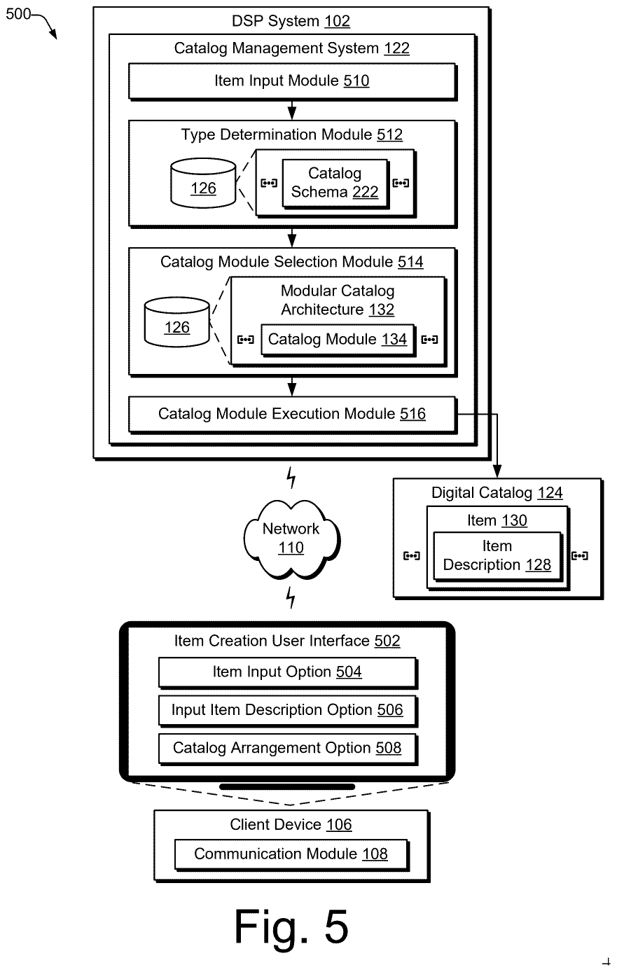

By utilizing this modular approach, the DSP system 102 can efficiently address the diverse merchant criteria without cluttering the user interface with irrelevant options or overburdening computational resources with irrelevant processing. This flexibility allows the catalog management system 122 and the DSP system 102 to efficient scale, accommodate new product categories or industry-specific criteria, and so on by simply adding or modifying plurality of catalog modules 134 within the existing modular catalog architecture 132 that may be reused in other scenarios. Further discussion of use of the catalog module and modular catalog architecture in digital catalog generation may be found in relation to FIGS. 5-7.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Catalog Module Generation

FIG. 2 depicts a system 200 in an example implementation showing operation of the catalog management system 122 of FIG. 1 in greater detail as generating a modular catalog architecture 132 of a plurality of catalog modules 134 in accordance with one or more implementations. To begin in this example, a catalog intake system 202 is employed to intake a digital catalog 204. An item identification module 206 is them employed to identify one or more item descriptions 208 from the digital catalog 204 and may do so in a variety of ways.

In a first example, the item identification module 206 parses the digital catalog 204 to locate the items descriptions 208, e.g., based on headers, product identifiers, and so forth. The item identification module 206, for instance, may process a multitude of product listings across various categories. For example, when analyzing the electronics category, the item identification module 206 may recognize product identifiers such as “SKU-12345” or headers such as “Smartphone Specifications” to isolate individual item descriptions 208. The item identification module 206 may then extract relevant details such as brand names (e.g., “TechGiant”), model numbers (e.g., “X2000”), and key features (e.g., “5G-enabled”, “6.5-inch OLED display”) from these descriptions.

In a second example, the item identification module 206 includes an item prompt generation module 210 that is configured to generate a prompt for processing by an LLM 212 to generate the one or more item descriptions 208 based on the digital catalog 204. The item prompt generation module 210, for instance, is configurable to create a structured prompt such as “Analyze the following product listing from the electronics category and extract key attributes including brand, model, technical specifications, and unique selling points.” This prompt, along with the raw product data from the digital catalog 204, is then fed into the LLM 212. The LLM 212, which has been trained on product data, processes this input and generates a standardized item description 208. For example, given a lengthy and unstructured listing for a smartphone, the LLM 212 outputs a concise, well-organized item description 208: “Brand: TechGiant; Model: X2000; Key Specs: 6.5-inch OLED display, 5G-enabled, 128 GB storage, 12 MP triple-lens camera; Features: Water-resistant, AI-powered voice assistant.” This approach allows the catalog management system 122 to rapidly process and normalize item descriptions 208 from various sources, ensuring consistency across the catalog management system 122 and improving searchability and user experience.

An element determination module 214 is then employed to determine one or more user interface elements 216 associated with the item description, which may also be based on the digital catalog 204 itself, including text, digital images, and so forth. In a first example, the element determination module 214 identifies recurring fields such as “Brand,” “Model,” “Storage Capacity,” and “Screen Size” across multiple listings and recognizes that these fields are consistently present and formatted similarly, often appearing as dropdown menus or text input fields. For clothing items, for instance, the element determination module 214 detects patterns indicating that “Size,” “Color,” and “Material” are frequently represented as selectable options. For digital products such as “software,” the element determination module 214 identifies that “Version Number,” “Compatibility,” and “License Type” are common elements, often presented as text fields or checkboxes. This rule-based approach allows the element determination module 214 to create a standardized set of user interface elements for each product category, ensuring consistency across the platform.

In a second example, the element determination module 214 includes a user interface prompt generation module 218 that is configured to generate a prompt for processing by the LLM 212. The prompt, for example, may be structured as: “Analyze the following item descriptions and identify the most appropriate user interface elements to capture each attribute. Consider factors such as data type, input format, and user experience.” For a concert ticket listing example, the LLM 212 processes the prompt and suggests a user interface element 216 such as a “date picker” for the event date, a dropdown menu for seating categories, and a numeric input for quantity. For a customizable product, the LLM 212 may recommend a color palette selector for base color, a file upload button for customer-provided images, and a text area for special instructions. As a result, the element determination module 214 is configured to dynamically generate user interface elements 216 tailored to each item's characteristics as described by the one or more item descriptions 208 and/or included in the digital catalog 204.

A schema generation module 220 is then employed to generate a catalog schema 222 for each item type from the plurality of item descriptions. The catalog schema 222 specifies content arrangement and respective user interface elements 216 for respective item descriptions 208. In a first example performed independent of machine learning, the schema generation module 220 analyzes item descriptions 208 for various product categories to create standardized schemas. For instance, when processing electronics items, the schema generation module 220 identifies common attributes such as “Brand,” “Model,” “Technical Specifications,” and “Connectivity Options.” The schema generation module 220 then arranges these elements in a logical order, placing basic information like brand and model at the top, followed by detailed specifications, and ending with optional features.

The schema generation module 220 also determines appropriate user interface elements for each attribute. For example, the schema generation module 220 may specify a text input field for brand name, a dropdown menu for product category, and a series of checkboxes for connectivity options. Similarly, for clothing items, the schema generation module 220 creates a schema with fields for “Size,” “Color,” “Material,” and “Care Instructions,” arranging these items in a typical order used by fashion retailers. Likewise, the schema generation module 220 may specify a size chart selection tool, a color swatch picker, and a text area for care instructions. This rule-based approach ensures consistency across similar items while tailoring the catalog schema 222 for each product category.

In a second example using machine learning, the schema generation module 220 includes a schema prompt generation module 224. The schema prompt generation module 224 is configured to generate a prompt for processing by the LLM 212. The prompt, for instance, may be structured as “Analyze the following set of item descriptions for [category] and generate an optimal catalog schema. Consider the attribute importance, logical arrangement, and the most user-friendly interface elements for each attribute.” For a digital product category like mobile applications, for instance, the LLM 212 processes this prompt along with a dataset of app descriptions and from this generates a catalog schema 222 that includes fields such as “App Name,” “Version,” “Compatibility,” “Key Features,” “In-App Purchases,” and “Privacy Policy.” The LLM 212 may also suggest arrangement of these fields in order of relative importance in user decision-making and recommend specific UI elements, e.g., a version number input with automatic update detection, a multi-select list for device compatibility, and an expandable section for detailed feature descriptions. For a complex category like customizable furniture, for example, the LLM 212 proposes a dynamic catalog schema 222 that adapts based on the type of furniture, with common fields like “Dimensions” and “Material,” but also customizable sections for specific features like “Upholstery Options” for sofas or “Finish Types” for wooden furniture. This machine learning approach configures the schema generation module 220 to generate an adaptable catalog schema 222 that may evolve over time based on changing market trends, user behaviors, and so forth.

An executable module generation module 226 is then utilized in one or more examples to form a plurality of catalog modules 134 that is executable to implement the catalog schema 222 and respective user interface elements 216. In a first example (independent of use of machine learning), the executable module generation module 226 may utilize predefined templates and rules to create catalog modules 134 for different item types. For instance, when generating a plurality of catalog modules 134 for electronic devices, the executable module generation module 226 uses a standardized template that includes sections for technical specifications, connectivity options, and power criteria.

The executable module generation module 226 is also programmable to dynamically adjust a modular user interface (i.e., modular UI 136) based on specific product attributes. The executable module generation module 226, for example, is programmable to cause display of a dropdown menu for screen size options when the item is identified as a television or monitor by the plurality of catalog modules 134. Similarly, for a catalog module 134 for clothing, the executable module generation module 226 is executable to incorporate size charts that vary based on the garment type (e.g., shirts vs. pants), and include functionality for displaying multiple product images to showcase different color options. This rule-based approach ensures consistency across similar items while allowing for customization based on predefined parameters for each product category in generation of the plurality of catalog modules 134.

In a second example using machine learning, the executable module generation module 226 employs an executable prompt generation module 228 to generate a prompt to cause the LLM 212 to generate the plurality of catalog modules 134. The executable module generation module 226, for instance, generates the prompt to include the catalog schema 222, one or more item descriptions 208, and/or the digital catalog 204 for processing by the LLM 212. In response, the plurality of catalog modules 134 is received as including the catalog schema 222 and a modular UI 136 that is renderable to include respective user interface elements 216.

The LLM 212 is also configurable to leverage a variety of other data sources. The LLM 212, for instance, may analyze user interaction data and sales performance metrics to optimize a structure and functionality of the plurality of catalog modules 134. For example, when generating a plurality of catalog modules 134 for digital products like software applications, the LLM 212 recognizes that user reviews and compatibility information significantly impact purchase decisions. As a result, the LLM 212 automatically prioritizes these elements in the modular UI 136, placing the user interface elements 216 prominently and designing interactive elements to highlight this information. In another example, for a complex product category such as customizable furniture, the LLM 212 generates a plurality of catalog modules 134 that dynamically adjusts configuration options presented to users in the modular UI 136 based on browsing history or previous purchases, potentially increasing conversion rates by prioritizing relevant choices. A variety of other examples are also contemplated.

The executable module generation module 226 is also configurable to organize the plurality of catalog modules 134 as part of a modular catalog architecture 132, such as to optimize a hierarchical arrange to increase computational efficiency. In one or more examples, the executable module generation module 226 implements the modular catalog architecture 132 to optimize catalog management, e.g., for a diverse range of merchants. The executable module generation module 226, for instance, analyzes user interaction patterns and item types across different merchant categories to dynamically adjust a hierarchical arrangement of catalog modules 134 within the modular catalog architecture 132. In one or more examples, the executable module generation module 226 may detect that fashion retailers frequently access plurality of catalog modules 134 for size charts, color variants, and material descriptions. In response, these catalog modules 134 are promoted to higher levels in the hierarchy of the modular catalog architecture 132 for fashion sellers, allowing quicker access and reducing navigation time. Conversely, a catalog module 134 related to digital download management or appointment scheduling, which is rarely used by fashion retailers, is moved to lower levels or hidden entirely for these users.

The executable module generation module 226 is also configurable to optimize computational resource usage by prioritizing loading and processing of relevant plurality of catalog modules 134 as part of the modular catalog architecture 132, e.g., based on a merchant's profile and recent activity. For example, when a restaurant owner accesses the catalog, the modular catalog architecture 132 is configurable to preemptively load catalog modules 134 for menu creation, nutritional information, and modifier options, while deferring the loading of catalog modules 134 for inventory tracking or shipping calculations. This approach reduces initial load times and minimizes irrelevant data processing by executing the catalog modules 134 at an “as relevant” basis. The executable module generation module 226 is also configurable to implement a caching mechanism as part of the modular catalog architecture 132 for frequently used catalog modules 134, further enhancing performance. In this way, the executable module generation module 226 improves user navigation efficiency and optimizes computational resource allocation, resulting in increased responsiveness and a tailored catalog management experience.

The catalog management system 122 further supports use of a verification user interface 230 that is usable to verify operation of the plurality of catalog modules 134 and respective user interface elements 216 generated. The verification user interface 230, as part of the catalog management system 122, is implemented in one or more examples to ensure proper functionality of the generated catalog modules 134 and respective user interface elements 216.

To do so, the verification user interface 230 is configurable to present a simulated environment where system administrators or quality assurance testers can interact with each catalog module 134, e.g., similar to merchants from various verticals. For instance, when testing a catalog module designed for a restaurant's menu items, the verification user interface 230 allows testers to create sample food items, add modifiers, set pricing tiers, and preview how these items would appear in different sales channels such as in-store point-of-sale systems and online ordering platforms.

The verification user interface 230 may also supports automated testing features that may cycle through different scenarios and edge cases. For example, the verification user interface 230 may automatically populate fields with extreme values, attempt to create items with missing required information, or simulate high-volume catalog updates to stress-test the system's performance. The verification user interface 230 is configurable to provide real-time feedback on errors or inconsistencies detected, such as misaligned user interface elements, incorrect data validation, or unexpected system behavior when switching between different item types. This verification process allows the catalog management system 122 to identify and address potential issues before the catalog modules 134 are deployed in live environments, thereby ensuring a smoother experience with increased reliability across diverse usage scenarios and catalog complexities.

Furthermore, the modular catalog architecture enables testing (e.g., A/B testing) of different catalog modules and/or modular user interface configurations, thereby supporting data-driven optimization of a user experience and catalog management system performance over time. For instance, a DSP system may implement the modular catalog architecture to optimize a merchant onboarding process. As part of this, the catalog management system tests two different configurations for new merchants, e.g., in a handmade jewelry category. In a first version, a first catalog module presents a simplified modular user interface with basic fields, e.g., product name, price, and a single image upload option. In a second version, a second catalog module offers a comprehensive modular user interface, e.g., including fields for materials used, production time, customization options, and multiple image uploads.

The catalog management system then randomly assigns new jewelry sellers to either the first or second versions of the catalog module over a period of time. During that time, the catalog management system is configurable to track various metrics, e.g., time spent creating listings, number of listings completed, listing quality scores, and eventual sales performance. Analysis of the data in this example reveals that while the first version results in faster initial listing creation, the second version leads to higher quality listings, better search visibility, and ultimately higher sales. Based on these insights, the catalog management system implements a hybrid approach, where new sellers begin with a simplified interface but are gradually introduced to advanced features as familiarity with the catalog management system increases. As a result, this data-driven optimization improves a user experience and also enhances overall system performance by increasing quality and diversity of the item descriptions.

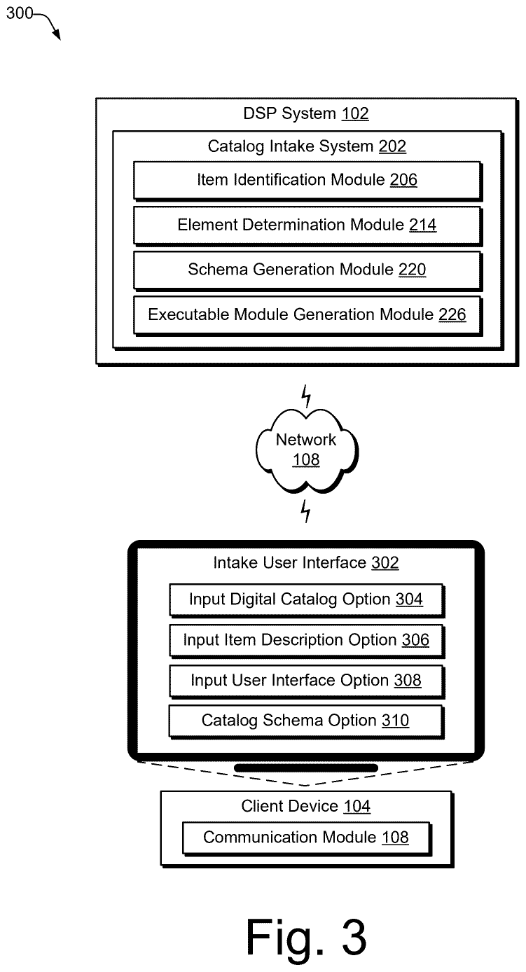

FIG. 3 depicts a system 300 in an example implementation of a client device 106 output of an intake user interface 302 usable to guide creation of a catalog module as part of a modular catalog architecture by a catalog intake system 202 of FIG. 2. The input digital catalog option 304 supports multiple techniques usable to import existing product data from a digital catalog 204 into the catalog management system 122. The input digital catalog option 304, for instance, is selectable to output a CSV/Excel file upload option for bulk import of structured data, supporting various file formats and column mappings to accommodate different catalog structures. This input digital catalog option 304 is also configurable to support intelligent field mapping and data validation to ensure reliable import. The input digital catalog option 304 may also support API integration for connectivity with third-party platforms allowing real-time synchronization of product data within the digital catalog 204. This integration supports initial digital catalog 204 import and also ongoing updates, ensuring the digital catalog 204 information remains current.

The input item description option 306 is selectable to output a set of options usable to create detailed and accurate product listings. Text fields, for instance, are supported to input information such as name, description, SKU, and price. The text fields may be complemented by advanced features such as a rich text editor for formatting detailed descriptions with HTML support. Image upload functionality may also be incorporated by the input item description option 306 to support input of multiple high-resolution product images, 360-degree views, and video content to showcase products effectively.

A hierarchical category selection system with customizable attributes is includable by the input item description option 306 to support product classification. In one or more examples, barcode/QR code scanner integration is supported by the input item description option 306 to streamline a process of adding physical products to the digital catalog, automatically populating fields with scanned product information, and so forth. Additionally, the input item description option 306 may incorporate generative artificial intelligence as implemented using machine learning (e.g., an AI-powered description generator) to generate product descriptions based on key features and attributes. In one implementation, AI-driven inference models 312 are implemented to personalize the catalog experience at scale. The inputs, such as onboarding data, catalog structure, and business metadata, may be rule-based, or used to automatically classify a seller's vertical, channel preferences, and catalog complexity based on patterns in their behavior and item data. For example, the system may analyze item names, category labels, and uploaded images to probabilistically determine whether a seller operates a restaurant, retail store, or service business. This inferred seller profile would then inform which user interface components are rendered during catalog interactions, ensuring that vertical-specific features (e.g., item modifiers for food and beverage, stock tracking for retail, or appointment packages for fitness) are presented proactively. Additionally, AI may detect signals like repeated manual variation entry (e.g., “Small,” “Medium,” “Large”) to suggest automatic conversion to structured item options. Over time, these models could enable a fully adaptive interface that anticipates seller needs before they articulate them, making catalog setup more intuitive and dramatically reducing setup time across complex, multichannel, and multivertical sellers.

The input user interface option 308 is selectable for managing user interface included by respective catalog modules 134 as the modular UI 136. A drag-and-drop interface builder, for instance, may be output by the input user interface option 308 for creation of custom layouts, with a library of pre-designed components. A template selection gallery may also be output by the input user interface option 308 that includes a range of item-specific templates that are then used as starting points. A custom field creator is usable to support a variety of input types such as text, number, dropdown, multi-select, and advanced options such as color pickers or date range selectors.

Layout options may also be output by the input user interface option 308, which may include responsive grid systems, list views, and interactive carousels, each of which are configurable to adapt to different screen sizes. In one or more examples, a conditional logic rules creator is usable to define dynamic behaviors, such as showing or hiding fields based on user inputs or selected options and a real-time mobile preview toggle may be included, e.g., to ensure the modular UI is optimized for both desktop and mobile users.

The catalog schema option 310 is selectable to output options in the intake user interface 302 for defining and managing a structure in a module UI output by a respective catalog module 134. The catalog schema option 310, for instance, may output the intake user interface 302 as a graphical interface for creating and modifying catalog schemas, with nodes representing entities (e.g., products, categories, attributes) and connections defining relationships between the nodes. In another example, a JSON/XML schema input field is supported by the catalog schema option 310 to support direct editing of the schema definition.

The catalog schema option 310 may also support predefined schema templates for common item types (e.g., clothing, electronics, books) to provide a starting point that may be subsequently customized. Inheritance and relationship mapping options may also be used by the catalog schema option 310 to input a definition of hierarchical structures and cross-entity relationships, supporting complex relationships between the plurality of catalog modules 134 as part of the modular catalog architecture 132. A variety of other examples are also contemplated.

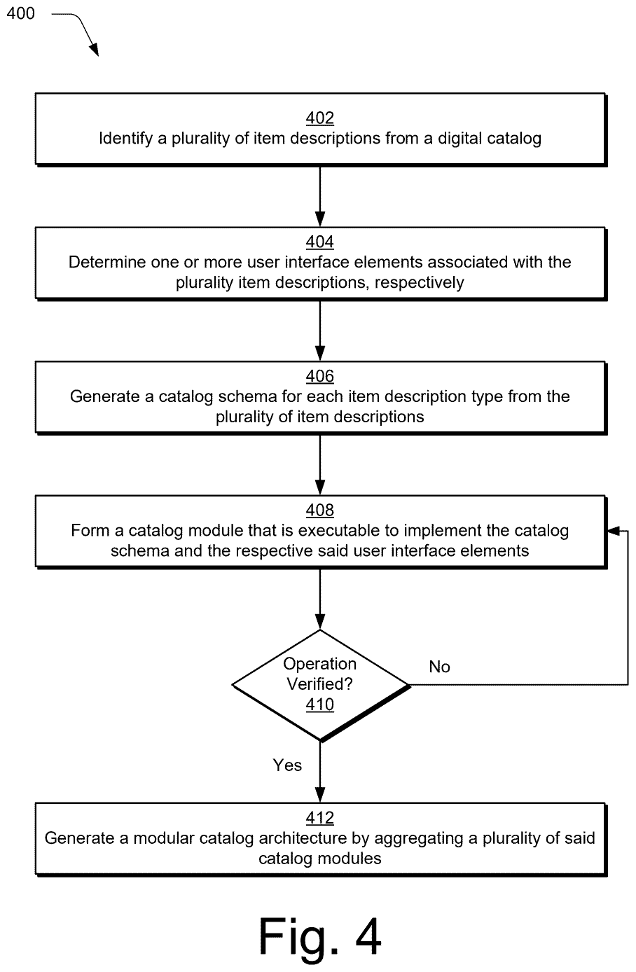

FIG. 4 is a flow diagram depicting a step-by-step procedure 400 in an example implementation of operations performable by a processing device for accomplishing a result of catalog module generation for inclusion as part of a modular catalog architecture in accordance with one or more implementations. The following discussion describes techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

To begin in this example, a plurality of item descriptions are identified from a digital catalog (block 402). This operation may be performed by the item identification module 206. For instance, the item identification module 206 may process a multitude of product listings across various categories in a platform, recognizing product identifiers like “SKU-12345” or headers such as “Smartphone Specifications” to isolate individual item descriptions.

A determination is then made that one or more user interface elements are associated with the plurality item descriptions, respectively (block 404). This step may be executed by the element determination module 214. In a real-world example, the element determination module 214 analyzes smartphone listings and identify recurring fields like “Brand,” “Model,” and “Storage Capacity,” recognizing that these fields are often presented as dropdown menus or text input fields.

A catalog schema is then generated for each item type from the plurality of item descriptions. The catalog schema specifies content arrangement and respective user interface elements for respective item descriptions (block 406). The schema generation module 220, for example, when processing electronics items creates a schema that arranges attributes like brand, model, and technical specifications in a logical order, specifying appropriate UI elements for each.

A catalog module is formed that is executable to implement the catalog schema and the respective said user interface elements (block 408). This task is performable by the executable module generation module 226. For instance, the executable module generation module 226 generates a catalog module 134 for electronic devices that support sections for technical specifications and connectivity options, with dynamic UI adjustments based on specific product attributes.

Operation of the catalog module is then verified (decision block 410). If operation is not verified (“no” from decision block 410), the procedure 400 returns to form a new catalog module. This verification process may be conducted using the verification user interface 230. For example, the verification user interface 230 as previously described supports testing, addition of modifiers, and previews of how these items appear in different sales channels to ensure desired functionality.

If operation is verified (“yes” from decision block 410), a modular catalog architecture 132 is generated by aggregating a plurality of catalog modules 134 (block 412). The modular catalog architecture 132 is configured to execute respective catalog modules 134 responsive to a determination of a type of item description from an input based on the catalog schema to create an item description as further described in the following section and shown in corresponding figures.

### Example Catalog Module Use in Digital Catalog Generation

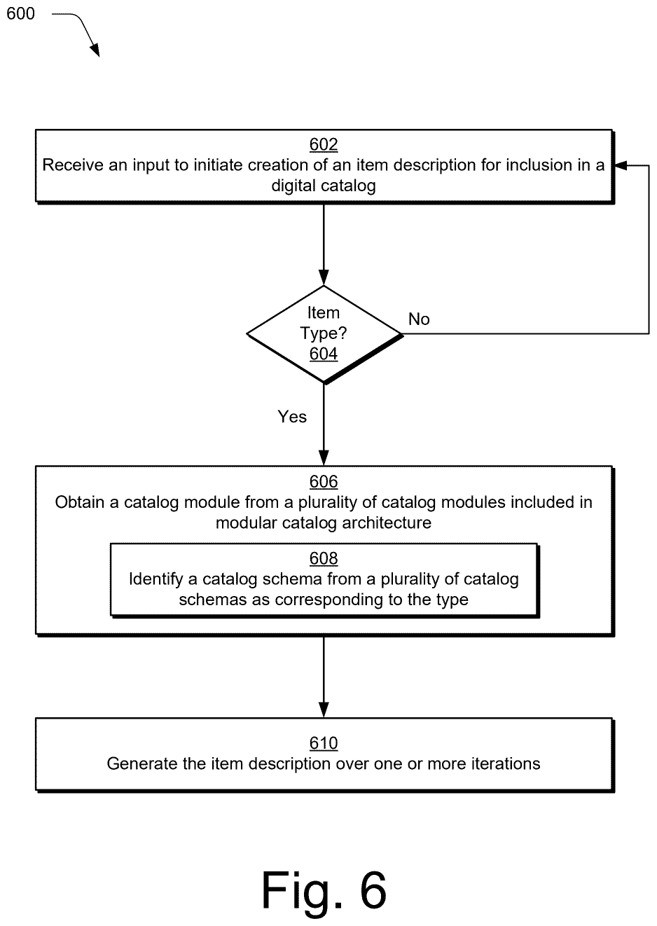

FIG. 5 depicts a system 500 in an example implementation showing operation of a catalog management system 122 as generating a digital catalog 124 using one or more catalog modules selected from a modular catalog architecture 132 in accordance with one or more implementations. FIG. 6 is a flow diagram depicting a step-by-step procedure 600 in an example implementation of operations performable by a processing device for accomplishing a result of item description generation and digital catalog generation using catalog modules of a modular catalog architecture of FIG. 2 in accordance with one or more implementations.

The following discussion describes techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference is made in parallel to FIGS. 5 and 6.

The catalog management system 122, for instance, receives an input to initiate creation of an item description for inclusion in a digital catalog (block 602). A client device 106 is depicted in FIG. 5 as displaying an item creation user interface 502 that is usable to guide generation of a digital catalog 124, and more particularly items 130 and items descriptions 128 in the digital catalog 124, through interaction with the catalog management system 122 of the DSP system 102. To do so, the item creation user interface 502 includes an item input option 504 usable to input data describing the items 130, an item description option 506 usable to input data pertaining to the item descriptions 128, and a catalog arrangement option 508 usable to arrange the items 130 within the digital catalog 124.

The catalog management system 122, for examples, receives an input via a item input option 504 to “Create New Item” and enter “Silver Moonstone Necklace” as the item name. A determination is then made by a type determination module 512 as to whether the input references an item type (decision block 604). The type determination module 512, for instance, may query the catalog schemas 222 to determine whether any one of the catalog schemas 222, and consequently the plurality of catalog modules 134, have a type supported by the input. If not (“no” from decision block 604), a prompt is output to provide additional information and the procedure 600 returns to receive the input (block 602). For example, if the type determination module 512 is usable to determine whether “Silver Moonstone Necklace” is a physical product or a digital design file, it might prompt the user to specify the item type.

If the input references an item type (“yes” from decision block 604), a catalog module 134 is obtained from a plurality of catalog modules included in a modular catalog architecture 132 (block 606) by a catalog module selection module 514. To do so, the catalog module selection module 514 also leverages a catalog schema 222 identified from a plurality of catalog schemas as corresponding to the type (block 608) and the obtains catalog modules 134 from the modular catalog architecture 132 that are associated with those catalog schemas 222. In this example, the catalog module selection module 514 recognizes “necklace” as a jewelry item and selects a catalog module specifically designed for jewelry products. The selected catalog module, in one or more examples, is associated with a set of interface elements and thereby filters out one or more interface elements associated with another catalog module of the plurality of catalog modules that are unrelated to an inferred item type. The selected catalog module is then executable to render variant management controls (e.g., when an inferred item type corresponds to a physical good) and thereby enable definition of variant attributes, pricing, and inventory in a tabular user interface as further described below.

The item description is then generated over one or more iterations (block 610) by a catalog module execution module 516 through execution of the catalog modules 134 obtained by the catalog module selection module 514. For the jewelry seller example, a series of prompts may be output to input details such as materials (silver, moonstone), dimensions, weight, closure type, and care instructions. The catalog module execution module 516, through execution of the catalog modules 134, may also suggest fields commonly used for jewelry items, such as gemstone properties or metal purity, adapting the interface based on the specific type of jewelry being listed. This prompting may be performed over a plurality of iterations to generate a digital catalog 124 having items and item descriptions 128. Execution of the catalog modules 134 is usable to control a layout of the item creation interface based on historical behavior indicating frequent or infrequency use of particular interface elements.

As previously described, catalog management presents significant technical challenges for entities across various scales and complexities of operations. The difficulty increases proportionally with catalog size and operational intricacies, such as multi-location, omnichannel, or multi-vertical selling scenarios. Recent efforts to enhance catalog functionality for upmarket entities across diverse verticals have resulted in the addition of numerous attributes and features to catalog-related interfaces. However, these additions are implemented without a cohesive framework, leading to suboptimal outcomes.

Conventional digital catalog generation systems, designed as a universal solution, fail to adequately address specific criteria of individual entities. Feedback from entities consistently indicates a perception that the DSP system's catalog tools are not tailored to a particular industry. Survey data corroborates this sentiment, with respondents rating the industry-specific suitability of catalog tools at a mediocre score. The overabundance of features in the catalog system imposes a cognitive burden on entities, tasking the entities with navigating through extensive, often irrelevant functionality during catalog management tasks. In the techniques described herein, however, support a large variety of audiences/verticals whereas conventional techniques typically focus on a single vertical.

Additionally, development of new catalog features has been hindered by the limitations of implementing vertical or channel-specific functionality within shared, general-purpose interfaces. As ecosystem of the DSP system 102 has expanded to encompass multiple verticals and serve complex upmarket entities, the practice of continually augmenting shared catalog user interfaces on a case-by-case basis, without comprehensive consideration of the impact on entities across all verticals (particularly those operating in multiple verticals), has reached its practical limits in real world scenarios.

Accordingly, the catalog management system 122 is configured to employ a modular catalog architecture 132 of plurality of catalog modules 134 to implement digital catalog 124 creation. The catalog management system 122, for instance, is configurable to construct a digital catalog 124 that appears specifically designed for each entity's business, regardless of operational complexity, verticals, or sales channels utilized.

The catalog management system 122, for instance, transforms a conventional universal item sheet into a dynamic experience that progressively reveals appropriate attributes at optimal times to entities, creating an impression that the catalog management system's 122 digital catalog 124 is custom-built for specific business criteria. Item categorization techniques are also configured to evolve to accommodate entities operating across various verticals.

To do so, a continuous feedback loop may be implemented by the catalog management system 122 and informed by known entity data and direct entity input to develop a comprehensive business profile that drives the entity's experience within the digital catalog 124. By establishing vertical and channel-specific frameworks within the digital catalog 124, the catalog management system 122 also provide partner teams at the DSP system 102 with increased flexibility and autonomy to implement features relevant to specific entities without negatively impacting other entities for whom these features may be irrelevant.

The catalog management system 122 is configurable to input a diverse array of entity data to construct a comprehensive understanding of each entity's business (e.g., an entity profile) and leverage this information to control the progressive revelation of the catalog experience to each entity. During general onboarding to the catalog management system 122, information is collected from each entity, such as business category and intended sales channels (in-person, online, or both). Entities registering through vertical-specific solutions demonstrate clear affinity with the given vertical. During post-general onboarding, entities may complete vertical-specific catalog import flows, indicating catalog complexity and intended sales channels. The catalog management system's 122 is also configurable to query entities about planned item types for sale, question potentially relocatable to general onboarding or a catalog-specific onboarding flow. Additionally, an entity's subscription tier informs the catalog management system 122 as to which specific features to emphasize, e.g., packages and memberships for paid appointment-based entities.

The catalog management system 122 is also configurable to leverage an entity's business name, physical locations, existing web presence, and third-party channel listings. This business information is typically publicly available and scrapable to help identify the entity's vertical, sales channels, and operational sophistication level.

Similar to business properties, the catalog management system 122 can refine vertical inference based on created item and category attributes (e.g., name, description, images). For instance, an entity creating a category “Appetizers” containing items “Bruschetta” and “Polpetti” is likely a restaurant, for which the digital catalog 124 is to promote food and beverage-related attributes and merchandising features.

Although entities often initiate catalog setup prior to establishing an online site, an entity's non-catalog site content (such as an About page or image galleries) may provide substantial business insights to the catalog management system 122, enabling further refinement of the entity's catalog experience. A variety of other examples is also contemplated.

Based on this inputs, the catalog management system 122 is configurable to provide a variety of outputs through execution of the plurality of catalog modules 134 as part of generating the digital catalog 124. The catalog management system 122, for instance, is configurable to output an item sheet as a primary interface within the catalog management system 122 with which an entity interacts. The catalog management system 122, in one or more examples progressively reveals portions of the item sheet as categorized along three criteria (e.g., complexity, verticals, and channels) through use of the plurality of catalog modules 134 of the modular catalog architecture 132.

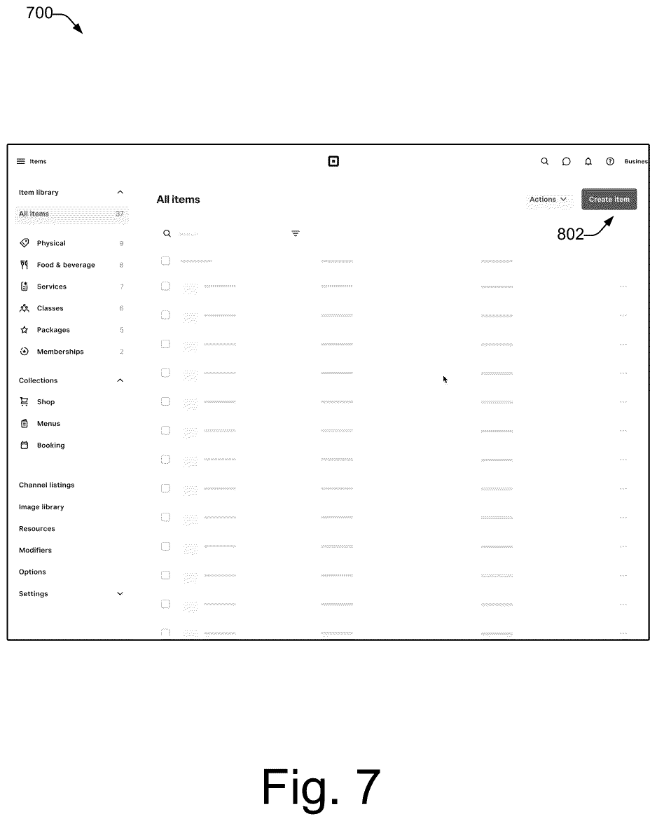

FIG. 7 depicts an example implementation 700 of the item creation user interface 502 of FIG. 5 configured as an item sheet in accordance with one or more implementations. An item sheet, for instance, may contain numerous attributes that may not be relevant to an entity in each instance of item creation, even with a strong understanding of corresponding vertical and sales channels. A quick create item mode initiated through selection of a “create item” 802 option is configured to leverage default options implemented by the catalog management system 122.

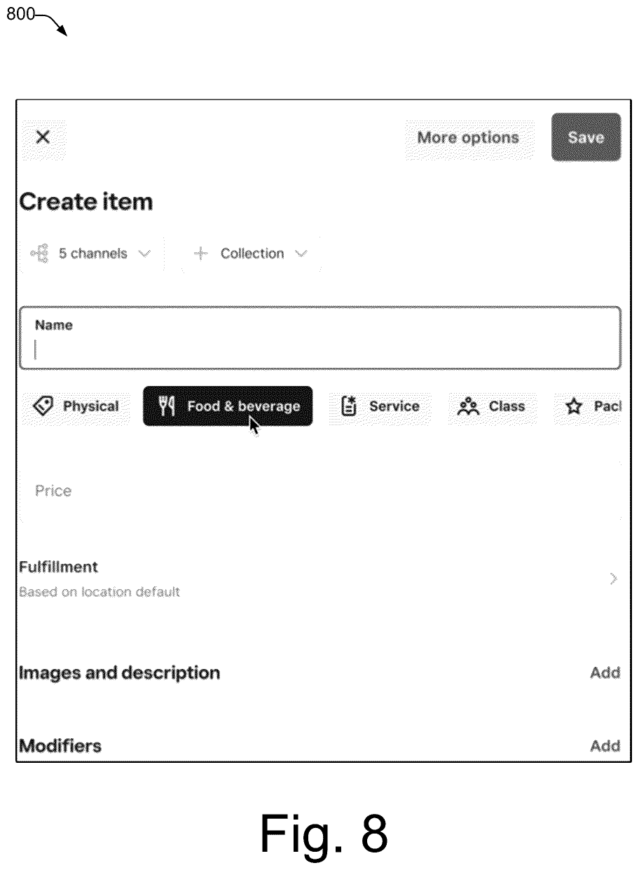

FIG. 8 depicts an example implementation 800 of the item creation user interface 502 of FIG. 5 configured to select from a plurality of default options responsive to selection of a create item option of FIG. 7 in accordance with one or more implementations. The quick create item mode through output of the default options may therefore reduce cognitive overhead for entities who do not desire a full breadth of item attributes for each item creation, without impacting ready-to-sell rates for each relevant channel. If the entity desires to further merchandise the item with additional details, accessing full functionality of the item sheet is achievable with a single interaction.

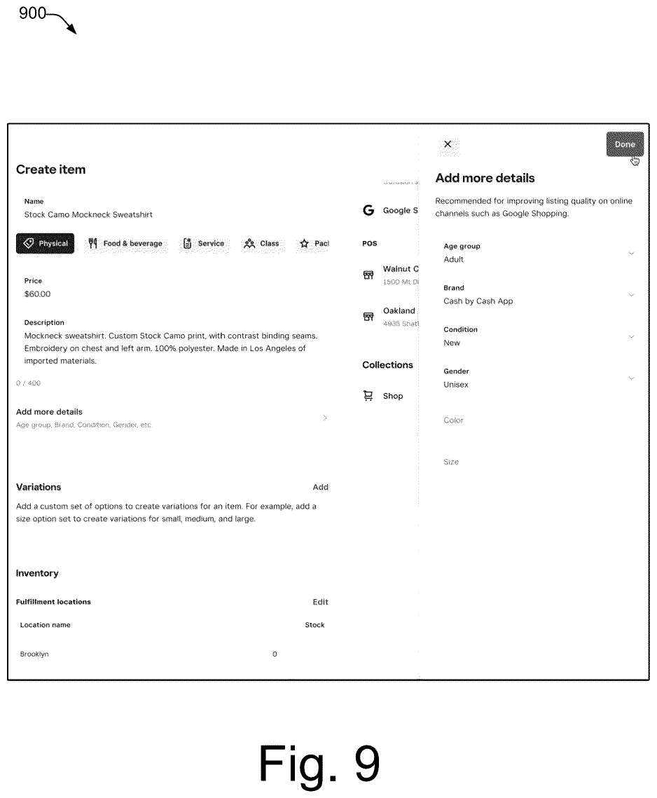

FIG. 9 depicts an example implementation 900 of the item creation user interface 502 of FIG. 5 configured to create an item as employing a read-only state in accordance with one or more implementations. In this example, a read-only state causes respective options in the user interface to be “grayed out.” As a result, cognitive overhead is reduced by deemphasizing item attributes that are not commonly edited.

Another example of progressive complexity is an entity's journey from creating an item with a single variation to multiple variations and eventually leveraging options to create numerous variations. The catalog management system 122, in this example, has an opportunity to contextually prompt an entity to create options based on activity in creating multiple variations, especially if the catalog management system 122 detects obvious indicators such as the use of common variation names (e.g., sizes and colors) or similar variations across multiple items. This approach allows the catalog management system 122 to adapt to the increasing complexity of an entity's catalog over time, providing relevant functionality as the entity's criteria evolve.

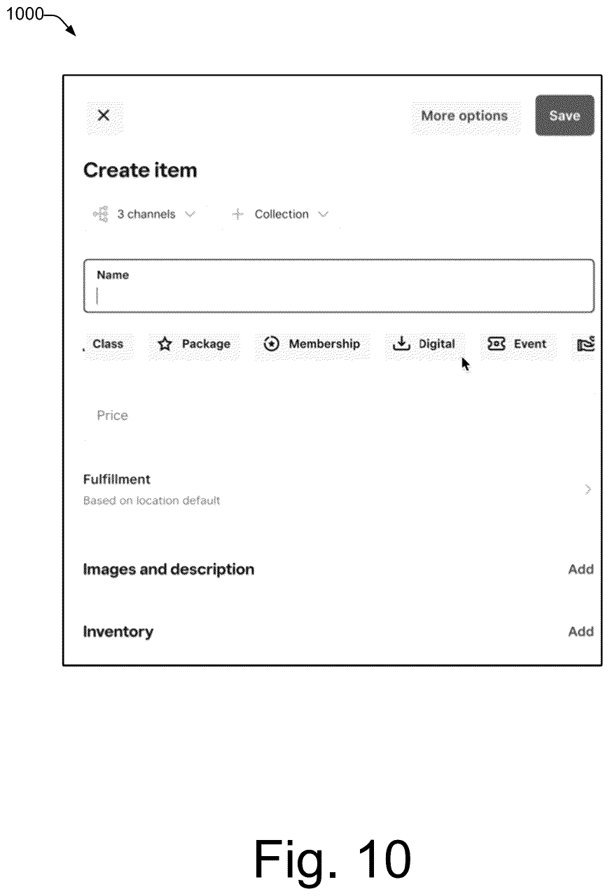

FIG. 10 depicts an example implementation 1000 of the item creation user interface 502 of FIG. 5 configured to leverage verticals in accordance with one or more implementations. Item types form a foundation for verticalizing the item sheet, enabling the catalog management system 122 to surface industry-relevant attributes at appropriate times to each entity. Internally, item types create spaces for vertical teams across the catalog management system 122 to build experiences that benefit respective entities without introducing bloat and irrelevant functionality to entities in other verticals.

Certain digital catalog concepts are predominantly vertical-specific, although exceptions exist. Modifiers are commonly utilized by food & beverage and service-oriented entities, whereas vendor attributes, stock tracking, and options are frequently employed by retail entities. The catalog management system 122 is configured to highlight catalog concepts relevant to the entity's vertical and the type of item being sold within the item sheet of the digital catalog 124. The catalog management system 122 is also configurable to deemphasize digital catalog concepts the entity is unlikely to use. This dynamic approach allows the catalog management system 122 to present a tailored interface that aligns with each entity's specific industry criteria, enhancing usability and efficiency in catalog management tasks.

In another example, with the foundation of item types in place, new item types may be created for classes, packages, and memberships, allowing the catalog management system 122 to build an offering for personal trainers, boutique gyms, and fitness studios. This approach allows the digital catalog 124 to provide tailored functionality for specific verticals while maintaining a streamlined experience for entities in other industries.

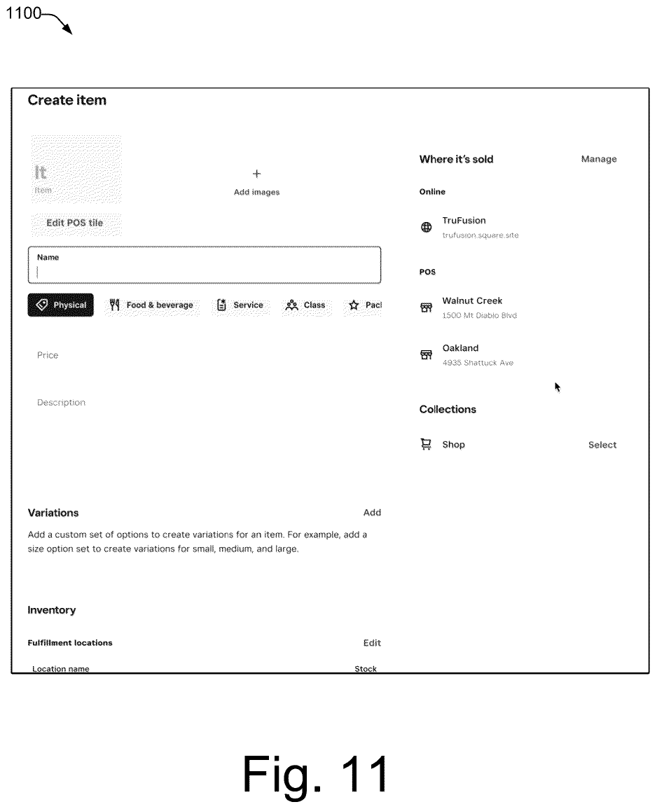

FIG. 11 depicts an example implementation 1100 of the item creation user interface 502 of FIG. 5 configured to leverage channels in accordance with one or more implementations. The location of item sales and fulfillment technical are usable by the catalog management system 122 to further influence a layout of the item sheet and the item attributes emphasized by the catalog management system 122. The “Where it's sold” section of the item sheet allows an establishment to indicate if an item is sold in-store via point-of-sale (POS), online via an online platform of the catalog management system 122, or through a third-party channel.

For example, a POS tile element of the item sheet is relevant to establishments selling items in-store via the POS and gender-related item attributes are relevant to establishments selling clothing through online shopping. Sales channels of an establishment influence item fulfillment plans, and the chosen fulfillment techniques informs the catalog management system 122 as to which item attributes are to be emphasized on the item sheet. For instance, the item weight attribute is relevant for a shippable item, especially if the establishment leverages real-time shipping calculations, but may present technical challenges if emphasized when the item is solely available for in-store pickup.

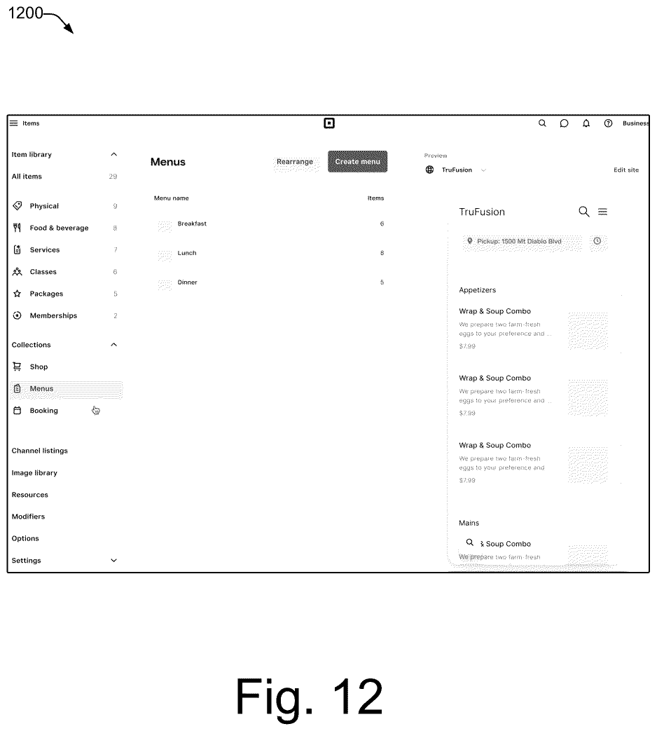

FIG. 12 depicts an example implementation 1200 of the item creation user interface 502 of FIG. 5 configured to leverage collections in accordance with one or more implementations. Collections enable establishments to merchandise items in appropriate buyer experiences. The illustrated example depicts a complex multihyphenate establishment selling retail items, food and beverage items, and services. Collections is a vertical merchandising framework configurable to allow establishments to group similar types of items together in a way that reflects the establishment vertical, thereby progressively revealing the complexity of the ecosystem. Collections may power vertical-specific shopping and ordering experiences that are intuitive for both customers ordering online and for cashiers building carts and checking out customers on the POS.

With collections, the catalog management system 122 empowers establishments to group items together for merchandising purposes by the verticals that are relevant to the business and clearly align the catalog with the buyer experience. This framework is extensible to accommodate additional verticals the catalog management system 122 is entering, such as Fitness (e.g. classes). Examples of collections include “shop” designed for a retail shopping experience, “menus” designed for a food and beverage ordering experience, and “booking” designed for a beauty, health and wellness booking experience. Collections may be implemented as advanced categories on a backend of the catalog management system 122.

The catalog management system 122 is also configurable to enable establishments to add vertical-specific pages to a corresponding website instead of forcing a layout selection, such that a single site could have both a retail shop and a restaurant online ordering page. Collections, in one or more examples, may strictly map to catalog management system 122 online vertical-specific pages and share identical names (Shop, Menus, Booking, etc.) to ensure a consistent establishment experience across the ecosystem. The items organized in “shop” are solely displayed in the analogous “shop” page online whereas the items organized in “menus” are solely displayed in an analogous “menus” page online. In this way, the catalog management system 122 provides establishments with greater control over merchandising of items, and multihyphenate establishment customers benefit from improved organization of retail shopping, food and beverage ordering, and service booking.

Collections are also configurable to power cart building and checkout experiences on the POS. Each collection may be accessible from a converged visual browse-enabled checkout experience so that establishments do not miss a sale. Vertical POS apps that interact with the catalog management system 122, for instance, may differentiate offerings from one another with vertical-specific functionality, like restaurants table mappings, appointments calendar view, and retail robust inventory functionality and reports. A variety of other examples are also contemplated.

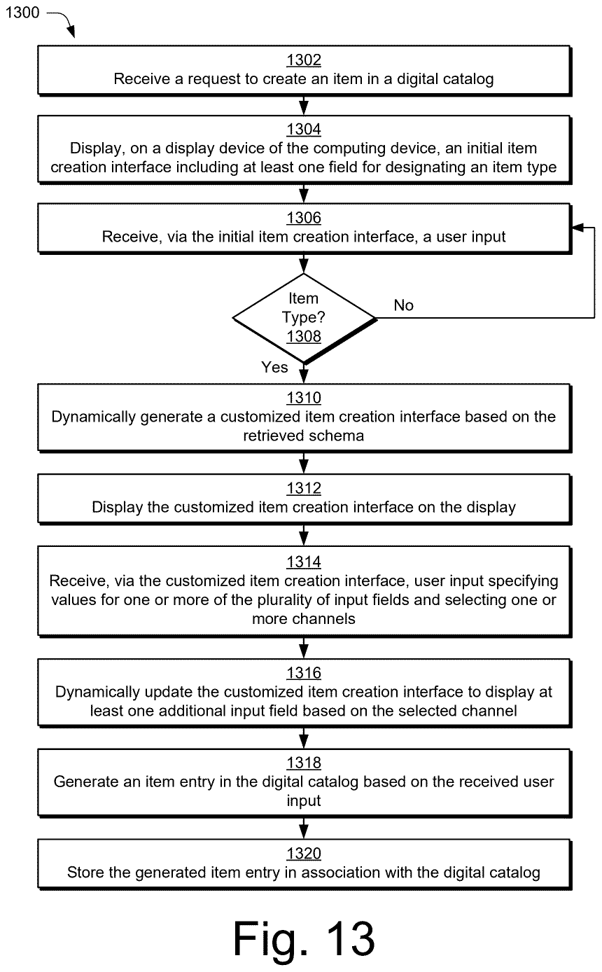

FIG. 13A is a flow diagram depicting a step-by-step procedure 1300 in an example implementation of operations performable by a processing device for accomplishing a result of digital catalog generation using catalog modules selected from a modular catalog architecture. To begin in this example, a request to create an item in a digital catalog is received (block 1302) by the catalog management system 122. For instance, a restaurant owner using the system may initiate the process of adding a new dish to their menu by selecting an “Add New Item” option in a catalog interface.

An initial item creation interface is then displayed on a display device of the computing device, including at least one field for designating an item type (block 1304). To do so, the catalog management system 122 supports output of a generalized user interface. A user input is then received via the initial item creation interface (block 1306), e.g., by the item input module 510.

A determination is then made by the type determination module 512 as to whether an item type has been designated (decision block 1308). If an item type is not determined (“no” from decision block 1308), the process loops back to receive additional input. When an item type is confirmed (“yes” from decision block 1308), a customized item creation interface is dynamically rendered based on the retrieved schema (block 1310). For instance, recognizing the “Main Course” designation, the catalog module selection module 514 locates a catalog module 134 configured to generate fields specific to entrees, such as “Ingredients,” “Allergens,” and “Portion Size.” The customized item creation interface is then displayed on the display (block 1312).

A user input is then received via the customized item creation interface, specifying values for input fields and selecting channels (block 1314). For example, inputs are received specifying pasta ingredients, setting the price, and selecting both “In-Restaurant” and “Online Ordering” as sales channels. The user interface is then dynamically updated to display additional input fields based on the selected channel (block 1316). If “Online Ordering” was selected, for instance, new fields for “Delivery Instructions” or “Packaging Notes” are displayed in a modular UI 136 by a respective plurality of catalog modules 134.

An item entry is generated in the digital catalog based on the received user input (block 1318). The catalog management system 122 compiles each of the entered and generated information into a structured catalog entry for the new pasta dish following the previous example. The generated item entry is then persisted in association with the digital catalog (block 1320). This ensures the new pasta dish is now officially part of the restaurant's digital menu maintained in the digital catalog 124. These techniques support a variety of usage scenarios.

Consider a scenario in which Elizabeth operates Coastal Cantina, a popular single-location eatery in a bustling coastal town. Coastal Cantina offers a curated menu of seafood tacos, burritos, and local craft beverages both in-store and through third-party delivery platforms. Coastal Cantina in this scenario uses an outdated point-of-sale system and has been for years, and as the contract expires, Elizabeth explores new options, namely the catalog management system 122.

The catalog management system 122 onboarding process is streamlined and user-friendly. Through a series of intuitive forms and conversational interfaces, the catalog management system 122 gathers information about Coastal Cantina's operations. The catalog management system 122 identifies Coastal Cantina as an omnichannel, single-location quick-service restaurant with existing third-party delivery partnerships. Based on this profile, the catalog management system 122 recommends a tailored suite of software and hardware solutions suited to Coastal Cantina's criteria and budget.

During initial setup, the catalog management system 122 offers to import Coastal Cantina's existing business and menu data from a third-party delivery profile. With a few clicks, Elizabeth imports the restaurant's logo, contact information, operating hours, fulfillment options, and a catalog of professionally photographed menu items, accelerating the setup process.

The catalog management system 122 directs Elizabeth to review her imported menu in the Catalog section of the dashboard. Coastal Cantina's fully merchandised food and beverage items are prominently displayed, and Elizabeth appreciates the interface's clear design for food service establishments. Examining the “Signature Surf Burrito” entry, for instance, Elizabeth is pleased to see her existing photos, description, pricing, and modifier options prominently featured. The system also offers new data fields for nutritional information, dietary specifications, and allergen details to enhance menu item descriptions.

Elizabeth explores the Menus section, which provides a visual preview of how Coastal Cantina's menu would appear on their new online ordering site. Impressed by how the pre-generated site already incorporates Coastal Cantina's branding, Elizabeth activates the site with a single click, instantly enabling online order capabilities. The Menus section also allows Elizabeth to customize the layout of her menu on the point-of-sale checkout interface, featuring visually appealing tiles for menu categories, items, and common functions.

After a month of successful operation with the catalog management system 122, Elizabeth decides to diversify Coastal Cantina's offerings by launching a branded merchandise line. Using a dashboard of the catalog management system 122, Elizabeth creates a new item entry for a t-shirt. The catalog management system 122 automatically categorizes this as a physical item and presents an item sheet tailored for retail products, prompting Elizabeth to input details like size and color options, inventory tracking, and apparel-specific attributes.

Elizabeth notices the t-shirt is automatically added to a new “Shop” collection, which creates a dedicated retail section on Coastal Cantina's existing online platform. She appreciates how the system seamlessly integrates both the restaurant menu and retail shop on a single site, each optimized for its specific customer experience. On the in-store point-of-sale system, Elizabeth can toggle between the food menu and merchandise sections when processing transactions.

Elizabeth is impressed with how the catalog management system 122 adapts to Coastal Cantina's evolving needs, guiding her through the process of effectively merchandising the restaurant's expanding catalog. The “Where it's sold” feature of the catalog management system 122, for instance, gives Elizabeth confidence in managing sales across multiple channels and locations as Coastal Cantina grows, ensuring she maintains control over her increasingly complex business operations which is not possible in conventional techniques.

FIG. 13B is a flow diagram depicting a step-by-step procedure in an example implementation of operations performable by a processing device for accomplishing a result of user interface element control and filtering based on relevant to user input data. The catalog management system 122 associates computer-executable code with a computing device of a merchant, such as the client device 106 (block 1352). This code is configured to dynamically render user interface elements of an item creation workflow. For example, a restaurant owner using the client device 106 to access the catalog management system 122 would have this code associated with their device, enabling a tailored item creation experience.

Utilizing the computer-executable code, an item designation user interface element is displayed via the user interface of the client device 106 (block 1354). This element is presented in association with the item creation workflow. For instance, the restaurant owner might see a dropdown menu or a set of buttons allowing them to designate whether they're adding a “Main Course,” “Appetizer,” or “Dessert” to a digital catalog 124.

The catalog management system 122 then receives first user input data indicating interaction with the item designation user interface element (block 1356). Continuing the restaurant example, the owner might select “Main Course” from the options presented.

Based on this first user input, the catalog management system 122 dynamically filters the user interface elements to generate a filtered set relevant to the item creation workflow (block 1358). For a “Main Course” designation, the system might filter out dessert-specific fields like “Sweetness Level” and instead include elements relevant to main dishes, such as “Protein Options” or “Spice Level.”

The filtered set of user interface elements is then presented in the user interface of the client device 106, utilizing the computer-executable code (block 1360). The restaurant owner would now see a tailored interface with fields specifically relevant to creating a main course item.

The catalog management system 122 then receives second user input data indicating information to be associated with the item in the digital catalog 124 (block 1362). For example, the restaurant owner might input details such as the dish name, description, price, and available sides.

Finally, the catalog management system 122 generates an item entry based on the item designation and the associated information for inclusion in the digital catalog 124 (block 1362). This entry would now be part of the restaurant's digital menu, accessible through various channels managed by the catalog management system 122.

FIG. 14 illustrates an example environment 1400 in which recommendation techniques described herein are performed in accordance with one or more implementations. The environment 1400 includes server(s) 1402 that can communicate over a network 1404 with end user devices 1406 and/or server(s) 1408 associated with third-party service provider(s). In various examples, the end user devices 1406 may comprise one or more seller devices 1406(A), one or more user devices 1406(B) and/or 1406(C) in a peer network, one or more content consumption devices 1406(D), one or more artist devices 1406(E), combinations of these examples, or other categories of user devices. The server(s) 1402 can be associated with one or more service providers that can provide one or more services for the benefit of users 1416, as described below. For example, the server(s) 1402 may enable services of service providers such as in association with a seller platform 1410 (which may further include a buyer platform), a peer-to-peer (P2P) payment platform 1412, a media content platform 1414, a combination of these platforms, or other platforms associated with other service providers. While services and features are referenced throughout in connection with a particular one of the seller platform 1410, the P2P payment platform 1412, or the media content platform 1414, it should be understood that any of these platforms may perform the functionality described in relation to any of the other platforms. Actions attributed to the service provider(s) can be performed by the server(s) 1402, e.g., a DSP system 102, client device 106, consume device 114, and so on.

In some examples, individual ones of the end user devices 1406 can be operable by users 1416. The users 1416 (individually referred to herein as “user 1416”) can be referred to as customers, buyers, merchants, sellers, borrowers, employees, employers, payors, payees, couriers, artists, musicians, listeners, fans, supervisors, hosts, audience members, and so on. The users 1416 can interact with the end user devices 1406 via user interfaces presented via the end user devices 1406. In at least one example, a user interface can be presented via a web browser, or the like. Alternatively or additionally, a user interface can be presented via an application, such as a mobile application or desktop application, which can be provided by the seller platform 1410, the P2P payment platform 1412, and/or the media content platform 1414, or which can be an otherwise dedicated application. In some examples, individual end user devices 1406 can have an instance or versioned instance of an application, which can be downloaded from an application store, for example, which can present the user interface(s) described herein.

In at least one example, the users 1416 can include merchants that can operate the seller device(s) 1406(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1406(A) can have an instance of a point of sale (“POS”) application 1420 stored thereon. The POS application 1420 can configure the seller device 1406(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1420 can determine transaction data associated with the POS transactions. Transaction data can include payment information, which can be obtained from a reader device 1422 associated with the seller device 1406(A), user authentication data, purchase amount information, point-of-purchase information (e.g., item(s) purchased, date of purchase, time of purchase, subscription type, etc.), etc. The POS application 1420 can send transaction data to the server(s) 1402 such that the server(s) 1402 can track transactions of the customers, merchants, and/or the users 1416 over time. Furthermore, the POS application 1420 can present a UI to enable the merchant to interact with the POS application 1420 and/or the seller platform 1410 via the POS application 1420.

In at least one example, the seller device 1406(A) can be a special-purpose computing device configured as a POS terminal (via the execution of the POS application 1420). In at least one example, the POS terminal may be connected to a reader device 1422, which is capable of accepting a variety of payment instruments, such as credit cards, debit cards, gift cards, short-range communication based payment instruments, and the like, as described below. In at least one example, the reader device 1422 can plug in to a port in the seller device 1406(A), such as a microphone port, a headphone port, an audio-jack, a data port, or other suitable port. In additional or alternative examples, the reader device 1422 can be coupled to the seller device 1406(A) via another wired or wireless connection, such as via Bluetooth®, BLE, and so on. In some examples, the reader device 1422 can be a software solution executing on the POS terminal, e.g., a mobile phone. In some examples, the reader device 1422 can read information from alternative payment instruments including, but not limited to, wristbands and the like.

In some examples, the reader device 1422 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1422, and communicate with the seller platform 1410, which can provide, among other services, a payment processing service. The server(s) 1402 associated with the seller platform 1410 can communicate with server(s) 1408, as described below. In this manner, the POS terminal and reader device 1422 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1422 of the POS system 1424 are shown as separate devices, in additional or alternative examples, the POS terminal and the reader device 1422 can be part of a single device. In some examples, the reader device 1422 can have a display integrated therein for presenting information to customers of a merchant. In additional or alternative examples, the POS terminal can have a display integrated therein for presenting information to the customers of the merchant. POS systems, such as the POS system 1424, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1422, whereby the reader device 1422 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1424, the server(s) 1402, and/or the server(s) 1408 may exchange payment information and transaction data to determine whether transactions are authorized. For example, the POS system 1424 may provide encrypted payment data, user authentication data, purchase amount information, point-of-purchase information, etc. (collectively, transaction data) to server(s) 1402 over the network(s) 1404. The server(s) 1402 may send the transaction data to the server(s) 1408.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1408 associated therewith) can forward the fund transfer request to an issuing bank (e.g., “issuer”). The issuer is a bank or financial institution that offers a financial account (e.g., credit or debit card account) to a user. The issuer (e.g., the server(s) 1408 associated therewith) can make a determination as to whether the customer has the capacity to absorb the relevant charge associated with the payment transaction. In at least one example, the seller platform 1410 can serve as an issuer and/or can partner with an issuer. The transaction is either approved or rejected by the issuer and/or the card payment network (e.g., the server(s) 1408 associated therewith), and a payment authorization message is communicated from the issuer to the POS device via a path opposite of that described above, or via an alternate path.

The server(s) 1408 may send an authorization notification over the network(s) 1404 to the server(s) 1402, which may send the authorization notification to the POS system 1424 over the network(s) 1404 to indicate whether the transaction is authorized. The server(s) 1402 may also transmit additional information such as transaction identifiers to the POS system 1424. In one example, the server(s) 1402 may include a merchant application and/or other functional components for communicating with the POS system 1424 and/or the server(s) 1408 to authorize or decline transactions (e.g., the API 1418). In examples, the seller platform 1410 can enable the merchants to receive cash payments, payment card payments, and/or electronic payments from customers for POS transactions and the service provider can process transactions on behalf of the merchants.

Based on the authentication notification that is received by the POS system 1424 from server(s) 1402, the merchant may indicate to the customer whether the transaction has been approved. In some examples, approval may be indicated at the POS system 1424, for example, at a display of the POS system 1424. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The seller platform 1410 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the user devices 1406 can access all of the services. In some cases, the user devices 1406 can have gradated access to the services, which can be based on risk tolerance, IDV outputs, subscriptions, and so on. In at least one example, access to such services can be availed to the merchants via the POS application 1420. In additional or alternative examples, each service can be associated with its own access point (e.g., application, web browser, etc.).

As the seller platform 1410 processes transactions on behalf of the merchants, the seller platform 1410 can maintain accounts or balances for the merchants in one or more ledgers. For example, the seller platform 1410 can analyze transaction data received for a transaction to determine an amount of funds owed to a merchant for the transaction and deposit funds into an account of the merchant. The account can have a stored balance, which can be managed by the seller platform 1410. The account can be different from a conventional bank account at least because the stored balance is managed by a ledger of the seller platform 1410 and the associated funds are accessible via various withdrawal channels including, but not limited to, scheduled deposit, same-day deposit, instant deposit, and a linked payment instrument.

A scheduled deposit can occur when the seller platform 1410 transfers funds associated with a stored balance of the merchant to a bank account of the merchant that is held at a bank or other financial institution (e.g., associated with the server(s) 1408). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the seller platform 1410 to the bank account of the merchant.

In at least one example, the seller platform 1410 may provide inventory management services. That is, the seller platform 1410 may provide inventory tracking and reporting. Inventory management services may enable the merchant to access and manage a database storing data associated with a quantity of each item that the merchant has available (i.e., an inventory). Furthermore, in at least one example, the seller platform 1410 can provide catalog management services to enable the merchant to maintain a catalog, which can be a database storing data associated with items that the merchant has available for acquisition (i.e., catalog management services). The seller platform 1410 can offer recommendations related to pricing of the items, placement of items on the catalog, and multi-party fulfillment of the inventory, to name a few examples.

In at least one example, the seller platform 1410 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the seller platform 1410 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the seller platform 1410 can provide financing services for offering and/or lending a loan to a borrower that is to be used for, in some instances, financing the borrower's short-term operational needs (e.g., a capital loan). Additionally or alternatively, the seller platform 1410 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The seller platform 1410 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The seller platform 1410 can provide web-development services, which enable users 1416 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the seller platform 1410 can recommend and/or generate content items to supplement omni-channel presences of the merchants.

Furthermore, the seller platform 1410 can provide payroll services to enable employers to pay employees for work performed on behalf of employers. In at least one example, the seller platform 1410 can receive data that includes time worked by an employee (e.g., through imported timecards and/or POS interactions), sales made by the employee, gratuities received by the employee, and so forth. Based on such data, the seller platform 1410 can make payroll payments to employee(s) on behalf of an employer via the payroll service. For instance, the seller platform 1410 can facilitate the transfer of a total amount to be paid out for the payroll of an employee from the bank of the employer to the bank of the seller platform 1410 to be used to make payroll payments. In at least one example, when the funds have been received at the bank of the seller platform 1410, the seller platform 1410 can pay the employee, such as by check or direct deposit.

Moreover, in at least one example, the seller platform 1410 can provide employee management services for managing schedules of employees. Further, the seller platform 1410 can provide appointment services for enabling users 1416 to set schedules for scheduling appointments and/or users 1416 to schedule appointments.

In some examples, the seller platform 1410 can provide restaurant management services to enable users 1416 to make and/or manage reservations, to monitor front-of-house and/or back-of-house operations, and so on. In such examples, the seller device(s) 1406(A) and/or server(s) 1402 can be configured to communicate with one or more other computing devices, which can be located in the front-of-house (e.g., POS device(s)) and/or back-of-house (e.g., kitchen display system(s) (KDS)). In at least one example, the seller platform 1410 can provide order management services and/or fulfillment services to enable restaurants (or other merchant types) to manage open tickets, split tickets, and so on and/or manage fulfillment services.

In some examples, the seller platform 1410 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the seller platform 1410 can leverage other merchants and/or sales channels that are part of the seller platform 1410 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the seller platform 1410 can enable conversational commerce via conversational commerce services, which can use one or more machine learning mechanisms to analyze messages exchanged between two or more users 1416, voice inputs into a virtual assistant or the like, to determine intents of user(s) 1416. In some examples, the seller platform 1410 can utilize determined intents to automate customer service, offer promotions, provide recommendations, or otherwise interact with customers in real-time. In at least one example, the seller platform 1410 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1416 may be new to the seller platform 1410 such that the user 1416 that has not registered (e.g., subscribed to receive access to one or more services offered by the seller platform 1410) with the seller platform 1410. The seller platform 1410 can offer onboarding services for registering a potential user 1416 with the seller platform 1410. In some examples, onboarding can involve presenting various questions, prompts, and the like to a potential user 1416 to obtain information that can be used to generate a profile for the potential user 1416. In at least one example, the seller platform 1410 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the seller platform 1410 can be transitioned to more permissive (e.g., less limited) or longer-term access to such services.

The seller platform 1410 can be associated with IDV services, which can be used by the seller platform 1410 for compliance purposes and/or can be offered as a service, for instance to third-party service providers (e.g., associated with the server(s) 1408). That is, the seller platform 1410 can offer IDV services to verify the identity of users 1416 seeking to use or using their services. Identity verification may involve requesting a customer (or potential customer) to provide information that is used by compliance departments to prove that the information is associated with an identity of a real person or entity (e.g., an artist). In at least one example, the seller platform 1410 can perform services for determining whether identifying information provided by a user 1416 accurately identifies the customer (or potential customer).

Techniques described herein can be configured to operate in both real-time/online and offline modes. “Online” modes refer to modes when devices are capable of communicating with the seller platform 1410 while offline mode refers to modes when devices are unable to communicate with the server(s) 1408 due to network connectivity issue, for example. In such examples, devices may operate in “offline” mode where at least some payment data is stored (e.g., on the seller device(s) 1406(A)) and/or the server(s) 1402 until connectivity is restored and the payment data can be transmitted to the server(s) 1402 and/or the server(s) 1408 for processing.

In at least one example, the seller platform 1410 can be associated with a hub, such as an order hub, an inventory hub, a fulfillment hub and so on, which can enable integration with one or more additional service providers (e.g., associated with the additional server(s) 1408). In some examples, such additional service providers can offer additional or alternative services and the service provider can provide an interface or other computer-readable instructions to integrate functionality of the service provider into the one or more additional service providers.

Turning now to the P2P functionality provided by the environment 1400, the P2P platform 1412 can provide a peer-to-peer payment service that enables peer-to-peer payments between two or more of the users 1416. Two or more of the users 1416 may be considered “peers” in a peer-to-peer interaction, such as a payment. In at least one example, the P2P platform 1412 can communicate with instances of a payment application 1426 (or other access point) installed on end user devices 1406 configured for operation by the users 1416. In an example, an instance of the payment application 1426 executing on a first user device 1406(B) operated by a payor (e.g., one of the users 1416) can send a request to the P2P platform 1412 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1416) via a peer-to-peer payment. In some examples, assets associated with an account of the payor are transferred to an account of the payee. In some examples, assets can be held at least temporarily in an account of the P2P platform 1412 prior to transferring the assets to the account of the payee.

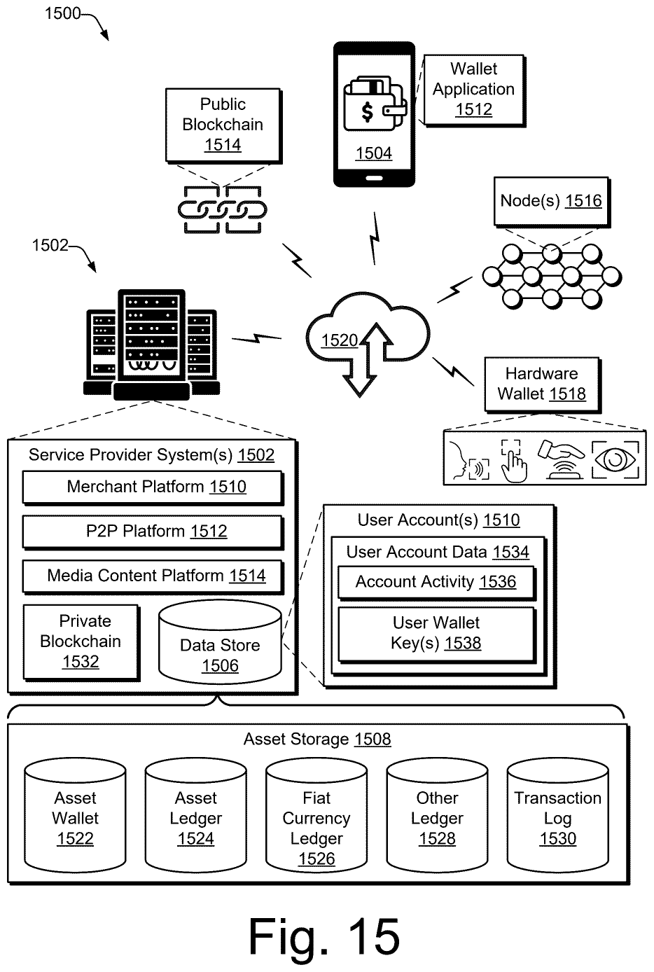

In some examples, the P2P platform 1412 can utilize a ledger system to track transfers of assets between users 1416. FIG. 15, below, provides additional details associated with such a ledger system. The ledger system can enable users 1416 to own fractional shares of assets that are not conventionally available. For instance, a user can own a fraction of a Bitcoin, an NFT, or a stock. Additional details are described herein.

In at least one example, the P2P platform 1412 can facilitate transfers and can send notifications related thereto to instances of the payment application 1426 executing on user device(s) of payee(s). As an example, the P2P platform 1412 can transfer assets from an account of a first user to an account of a second user and can send a notification to the user device 1406(B) of the second user for presentation via a user interface. The notification can indicate that a transfer is in process, a transfer is complete, or the like. In some examples, the P2P platform 1412 can send additional or alternative information to the instances of the payment application 1426 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1412 funds the request to payee on behalf of the payor, to speed up the transfer process and compensate for lags that may be attributed to the payor's financial network.

In some examples, the P2P platform 1412 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1402 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ) , yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1426 executing on the end user devices 1406. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1412 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 14 or a third-party service provider associated with the server(s) 1408. In examples where the content provider is a third-party service provider, the server(s) 1408 can be accessible via one or more APIs 1418 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1412 (e.g., the P2P platform 1412 offers a chat or messaging service that is within the payment application or accessible via the payment application). In some examples, the messaging application can be external to the P2P platform 1412. (e.g., the messaging application is hosted by a third-party service provider associated with the server(s) 1408, which can be accessible via one or more of the APIs 1418 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1412 can enable users 1416 to perform banking transactions via instances of the payment application 1426. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1412 can enable users to allocate funds between different accounts, sub-accounts, or balances (e.g., spending, saving, different assets, different currencies), etc. Further, users 1416 can configure bill pay, recurring payments, and/or the like using assets associated with their accounts. In some examples, the P2P platform 1412, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1412 enables users to buy and/or sell assets via asset networks such as cryptocurrency networks, securities networks, and/or the like. In some examples, acquisition of such assets can be in whole or fractional shares. The ledger system described below with reference to FIG. 15 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1412 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1412 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1412 can automatically apply the amount of funds associated with the gift card to the transaction.

In some examples, users can configure their account such that when they use their payment instruments, the P2P platform 1412 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1412 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1412 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1412 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1412.

In some examples, components of the environment 1400 may be integrated to enable payments at the point-of-sale using assets associated with user accounts of the P2P platform 1412. As illustrated in the environment 1400, the components can communicate with one another via the network 1404, where one or more APIs 1418 or other functional components can be used to facilitate such communication.

In at least one example, an integration can enable a customer to participate in a transaction via their own computing device (e.g., user device 1406(B)) instead of interacting with a merchant device of a merchant, such as the seller device 1406(A). In such an example, the POS application 1420, associated with a payment processing platform and executable by the seller device 1406(A) of the merchant, can present a Quick Response (QR) code, or other code that can be used to identify a transaction (e.g., a transaction code), in association with a transaction between the customer and the merchant. The QR code, or other transaction code, can be provided to the POS application 1420 via an API 1418 associated with the peer-to-peer payment platform. In an example, the customer can utilize their own computing device, such as the user device 1406(B), to capture the QR code, or the other transaction code, and to provide an indication of the captured QR code, or other transaction code, to server(s) 1402.

Based at least in part on the integration of the peer-to-peer payment platform and the payment processing platform (e.g., via the API 1418), the server(s) 1402 of the seller platform 1410 can exchange communications with a payment application 1426 associated with the P2P platform 1412 and/or the POS application 1420 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1412 and seller platform 1410 (which can be a first-or third-party integration) such that a QR code, or other transaction code, specific to the transaction can be used for providing transaction details, location details, customer details, or the like to a computing device of the customer, such as the user device 1406(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1406(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1420 and the payment application 1426, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1406(B), can be specially configured as a buyer-facing device having functionality similar to the functionality described above in the brick-and-mortar example.

In some examples, based at least in part on capturing the QR code, or other transaction code, the seller platform 1410 can provide transaction data to the P2P platform 1412 for presentation via the payment application 1426 on the computing device of the customer, such as the user device 1406B(B), to enable the customer to complete the transaction via their own computing device. In some examples, in response to receiving an indication that the QR code, or other transaction code, has been captured or otherwise interacted with via the customer computing device, the P2P platform 1412 can determine that the customer authorizes payment of the transaction using funds associated with a stored balance of the customer that is managed and/or maintained by the P2P platform 1412. Such authorization can be implicit such that the interaction with the transaction code can imply authorization of the customer. Alternatively or additionally, the P2P platform 1412 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1412 can transfer funds from the stored balance of the customer to the seller platform 1410. In at least one example, the seller platform 1410 can deposit the funds, or a portion thereof, into a stored balance of the merchant that is managed and/or maintained by the seller platform 1410. In such an example, the seller platform 1410 can be a “peer” to the customer in a peer-to-peer transaction.

In some examples, techniques described herein can enable the customer to interact with the transaction after payment for the transaction has been settled. For example, in at least one example, the seller platform 1410 can cause a total amount of a transaction to be presented via a user interface associated with the payment application 1426 such that the customer can provide gratuity, feedback, loyalty information, or the like, via an interaction with the user interface. In another example, the seller platform 1410 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1412, if the customer inputs a tip and/or an event affecting the total amount of the transaction is triggered, the P2P platform 1412 can transfer additional funds, associated with the tip or event, to the seller platform 1410. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1426 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1412 as described herein (e.g., a debit card linked to a stored balance of a customer) such that when the payment instrument is caused to interact with a payment reader, the seller platform 1410 can exchange communications with the P2P platform 1412 to authorize payment for a transaction and/or provision associated transaction data to a computing device of the customer associated with the transaction.

Turning now to media content functionality provided by the environment 1400, the media content platform 1414 can provide digital media to a content consumption device 1406(D) where playback may occur using “streaming.” In examples, “streaming” media content involves encoding the media content and transmitting the encoded media content over the network 1404 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1414 can provide a digital media streaming service (e.g., subscription-based, non-subscription-based) that enables a content consumption device 1406(D) to stream and/or download digital media content via a listener application 1428 installed on the content consumption device 1406(D). For instance, the media content platform 1414 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1406(D), the listener application 1428 may verify access rights to the digital media content items at time intervals, for instance intermittently (e.g., when the content consumption device 1406(D) has a network connection with the media content platform 1414 via the network(s) 1404), and/or at regular intervals (e.g., daily, weekly, monthly, etc.). In examples, access rights to the digital media content items may be provided when a subscription to the media content platform 1414 is active, while access rights to the digital media content items may be withheld when the subscription to the media content platform 1414 is terminated. Enabling storage on the end user devices 1406 and subsequent access to digital media content items via the listener application 1428 provides the users 1416 with the ability to access the digital media content items “offline” such as when a connection to the media content platform 1414 via the network(s) 1404 is unavailable or unreliable.

In some examples, the media content platform 1414 may additionally or alternatively provide an artist management service that enables the users 1416 to manage aspects of artist business via an artist application 1430 installed on the artist device 1406(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1416 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1416 may have access to a single user account via respective end user devices 1406, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1430 and the listener application 1428 may be distinct applications having differing user experiences and verification processes for access, such as illustrated in the environment 1400. For instance, the media content platform 1414 may request additional verification, such as a link to an artist website, a sample of an artist's work, a verified credential supplied by a third party, etc. to grant access to the artist application 1430 in addition to information requested to access the listener application 1428. Further, the artist application 1430 may provide the artist management services described herein, without the subscription-based digital media streaming services described herein, and vice versa. However, examples are also considered in which functionality provided by the artist application 1430 and the listener application 1428 partially or fully overlap, and/or where verification processes for access are substantially similar.

In at least some examples, the media content platform 1414 enables interaction between the users 1416 utilizing the listener application 1428 installed on the content consumption devices 1406(D), and the users 1416 utilizing the artist application 1430 installed on the artist devices 1406(E). For example, the media content platform 1414 may provide interconnectivity between the subscription-based digital media streaming service and the artist management service. Functionality provided by the media content platform 1414 in such instances may include a communication channel between one or more of the users 1416 (e.g., a listener, fan, music supervisor, publisher, etc.) utilizing the listener application 1428 and another user (e.g., an artist) of the users 1416 utilizing the artist application 1430. The communication channel may include, for instance, a messaging platform (also referred to as a “messaging application” herein), a live streaming platform, a videoconferencing or teleconferencing platform, and/or a combination of these.

Additionally, in some cases, the media content platform 1414 may facilitate a resource transfer between the listener application 1428 and the artist application 1430. In an example, the media content platform 1414 may direct a resource, such as a portion of a subscription fee paid by one of the users 1416 designated as a listener, to one or more of the users 1416 designated as artists based on a number of instances that the listening user consumed (e.g., streamed, downloaded, etc.) content created by respective ones of the artist users. Alternatively or additionally, the media content platform 1414 may direct a resource, such as funds, from an account associated with a listening user to an account associated with an artist user (or vice versa), in accordance with transfers between accounts as described herein. The media content platform 1414 may facilitate resource transfers in examples such as merchandise purchases, event ticket purchases, “tipping” an artist, payments for royalties or other fees, and so forth.

In some examples, the media content platform 1414 enables interaction between individual ones of the users 1416 with one another via the listener application 1428 installed on the content consumption device 1406(D) and other of the content consumption devices 1406(D) via a communication channel as described above. In an example, the listener application 1428 may provide functionality via a communication channel for a user to stream an individual digital media item, a playlist, or the like to an audience comprising other ones of the content consumption devices 1406(D). Alternatively or additionally, the communication channel may facilitate sharing of individual digital media items, playlists, user and/or artist profiles, and the like between the users 1416 via messages, uniform resource locators (URLs), quick response (QR) codes, and so forth.

In some cases, the media content platform 1414 enables interaction between individual ones of the users 1416 with one another via the artist application 1430 installed on the artist device 1406(E) and other of the artist devices 1406 via a communication channel as described above. In some instances, the media content platform 1414 may provide recommendations for a particular user indicating which of the other users 1416 to communicate with. Such a recommendation may be based on a similarity (or dissimilarity) of content created by two or more of the users 1416, an overlap (or lack thereof) of audience members of the users 1416, a geographic location of the users 1416, a coinciding event location of the users 1416, and so forth. In some examples, a user may input parameters for a desired connection via the artist application 1430, and the media content platform 1414 may filter which of the users 1416 to surface for recommendations to the user based on the input parameters. Alternatively or additionally, the media content platform 1414 may implement one or more machine learning models to filter which of the users 1416 to surface for recommendations to the user. The recommendations provided by the media content platform 1414 may be data driven and thus increase relevance of communications presented to the users 1416 and reduce unsolicited communications that may be received by the users 1416.

The media content platform 1414 may interact with the server(s) 1408 associated with the third-party service providers to, for instance, ingest digital media items, report digital media consumption data, pay royalties, and the like. In some examples, the server(s) 1408 may be accessible by the media content platform 1414 via one or more APIs 1418 or other integrations. In some cases, the third-party service provider may be a digital media content provider (e.g., a record label, a performance rights organization (PRO), an independent artist, etc.). In such cases, the media content platform 1414 may receive digital media content items from the server(s) 1408, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1414 may use the metadata to associate the digital media content item as being created by a particular user, to provide search results to the users 1416, to generate playlists, and so forth. Further, the media content platform 1414 may provide payments (e.g., royalties) to the third-party service provider based on a number of streams and/or downloads of individual digital media content items by the users via the listener application 1428.

Techniques described herein are directed to services provided via a distributed system of end user devices 1406 that are in communication with server(s) 1402 of the service provider. That is, techniques described herein are directed to a specific implementation—or, a practical application—of utilizing a distributed system of end user devices 1406 that are in communication with server(s) 1402 of the seller platform 1410, the P2P platform 1412, and/or the media content platform 1414 to perform a variety of services, as described above. The unconventional configuration of the distributed system described herein enables the server(s) 1402 that are remotely-located from end-users (e.g., users 1416) to intelligently offer services based on aggregated data associated with the end-users, such as the users 1416 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the seller platform 1410, the P2P platform 1412, and/or the media content platform 1414, and those outside of the control of these service providers, to track the standing (payables, receivables, payroll, invoices, appointments, capital, balances, collaborations, etc.) of the users 1416. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1416 and end user devices 1406. Furthermore, such features are changed dynamically based on the profiles of the users involved interacting with the GUIs. As such, techniques described herein are directed to improvements to computing systems.

The seller platform 1410, the P2P platform 1412, and/or the media content platform 1414 are capable of providing additional or alternative services, and the services described above are offered as a sampling of services. In at least one example, the seller platform 1410, the P2P platform 1412, and/or the media content platform 1414 can exchange data with the server(s) 1408 associated with third-party service providers. Such third-party service providers can provide information that enables the seller platform 1410, the P2P platform 1412, and/or the media content platform 1414 to provide services, such as those described above. In additional or alternative examples, such third-party service providers can access services of the seller platform 1410, the P2P platform 1412, and/or the media content platform 1414. That is, in some examples, the third-party service providers can be subscribers, or otherwise access, services of the seller platform 1410, the P2P platform 1412, and/or the media content platform 1414.

FIG. 15 illustrates an example environment 1500 including a service provider system 1502 which may be associated with the server(s) 1402 of FIG. 14. The environment 1500 may also include a user device 1504, which may correspond to any of the end user devices 1406 described in relation to FIG. 14. In examples, the service provider system 1502 may include one or a combination of the seller platform 1410, the P2P platform 1412, or the media content platform 1414, as well as one or more data store(s) 1506 that can store assets in an asset storage 1508, as well as data in user account(s) 1510. In some examples, the environment 1500 may also include a public blockchain 1514, one or more nodes 1516, and/or a hardware wallet 1518. The service provider system 1502, the user device 1504, public blockchain 1514, the node(s) 1516, and the hardware wallet 1518 may be connected and able to communicate via one or more networks 1520, which may have the same or similar functionality described in relation to the network 1404 of FIG. 14.

In some examples, user account(s) 1510 can include merchant account(s), customer account(s), media content subscriber account(s), artist account(s), and so forth. In at least one example, the asset storage 1508 can be used to record whether individual assets are registered to a user account 1510. For example, the asset storage 1508 can include asset wallet(s) 1522 for storing records of assets owned by the service provider system 1502, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1408 of FIG. 14 can be associated therewith.

The asset wallet 1522 can be associated with one or more addresses and can vary addresses used to acquire assets (e.g., from the asset network(s)) so that its holdings are represented under a variety of addresses on the asset network. In examples where the service provider system 1502 has holdings of cryptocurrency (e.g., in the asset wallet 1522), a user can acquire cryptocurrency directly from the service provider system 1502. In some examples, the service provider system 1502 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1502 can provide the same or similar functionality for securities or other assets.

The asset storage 1508 may contain ledgers that store records of assignments of assets to users 1416. Specifically, the asset storage 1508 may include asset ledger 1524, fiat currency ledger 1526, and/or other ledger(s) 1528, which can be used to record transfers of assets between users 1416 and/or one or more third-parties (e.g., merchant network(s), payment card network(s), ACH network(s), equities network(s), the asset network, securities networks, etc.). In doing so, the asset storage 1508 can maintain a running balance of assets managed by the service provider system 1502. The ledger(s) of the asset storage 1508 can further indicate some of the running balance for individual ledger(s) stored in the asset storage 1508 are assigned or registered to one or more user account(s) 1510.

In at least one example, the asset storage 1508 can include transaction logs 1530, which can include, as transaction data, records of past transactions involving the service provider system 1502 and/or the user account 1510. In some examples, the data store(s) 1506 can store a private blockchain 1532. A private blockchain 1532 can function to record sender addresses, recipient addresses, public keys, values of cryptocurrency transferred, and/or can be used to verify ownership of cryptocurrency tokens to be transferred. In some examples, the service provider system 1502 can record transactions involving cryptocurrency until the number of transactions has exceeded a determined limit (e.g., number of transactions, storage space allocation, etc.). Based at least in part on determining that the limit has been reached, the service provider system 1502 can publish the transactions in the private blockchain 1532 to the public blockchain 1514 (e.g., associated with the asset network), where miners can verify the transactions and record the transactions to blocks on the public blockchain 1514. In at least one example, the service provider system 1502 can participate as miner(s) at least for transactions to which the respective platform is a party to, to be posted to the public blockchain 1514.

In some cases, the data store(s) 1506 can store and/or manage multiple user accounts, an example of which is described in relation to the user account 1510. In at least one example, the user account 1510 can include user account data 1534, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1534 can include account activity 1536 and user wallet key(s) 1538. In some examples, the user wallet key(s) 1538 can include a public-private key-pair and a respective address associated with the asset network or other asset networks. In some examples, the user wallet key(s) 1538 may include one or more key pairs, which can be unique to the asset network or other asset networks.

In addition to the user account data 1534, the user account 1510 can include ledger(s) for account(s) managed by the service provider system 1502, for the user. For example, the user account 1510 may include an asset ledger 1524, a fiat currency ledger 1526, and/or one or more other ledgers 1528. The ledger(s) can indicate that a corresponding user utilizes the service provider system 1502 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1502.

In some examples, the asset ledger 1524 can store a balance for each of one or more cryptocurrencies (e.g., Bitcoin, Ethereum, Litecoin, etc.) registered to the user account 1510. In at least one example, the asset ledger 1524 can further record transactions of cryptocurrency assets associated with the user account 1510. For example, the user account 1510 can receive cryptocurrency from the asset network using the user wallet key(s) 1538. In some examples, the user wallet key(s) 1538 may be generated for the user upon request. User wallet key(s) 1538 can be requested by the user in order to send, exchange, or otherwise control the balance of cryptocurrency held by the service provider system 1502 (e.g., in the asset wallet 1522) and registered to the user. In some examples, the user wallet key(s) 1538 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 1502 and the value is credited as a balance in asset ledger 1524), by purchasing currency in the form associated with the account using currency in a different form (e.g., buying a value of cryptocurrency from the service provider system 1502 using a value of fiat currency reflected in fiat currency ledger 1526, and crediting the value of cryptocurrency in asset ledger 1524), or by conducting a transaction with another user (customer or merchant) of the service provider system 1502 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1502 (i.e., an external account). Such a transaction can request that the user to transfer an amount of the cryptocurrency in a message signed by user's private key to an address provided by the service provider system 1502. In at least one example, the transaction can be sent to miners to bundle the transaction into a block of transactions and to verify the authenticity of the transactions in the block. Once a miner has verified the block, the block is written to the public blockchain 1514 where the service provider system 1502 can then verify that the transaction has been confirmed and can credit the user's asset ledger 1524 with the transferred amount. When an account is funded by transferring cryptocurrency from a third-party cryptocurrency wallet, an update can be made to the public blockchain 1514. In some cases, this update of the public blockchain 1514 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1502. As described above, in some examples, the service provider system 1502 can acquire cryptocurrency from a third-party source. In examples where the service provider system 1502 has its own cryptocurrency assets, cryptocurrency transferred in a transaction (e.g., data with address provided for receipt of transaction and a balance of cryptocurrency transferred in the transaction) can be stored in an asset wallet 1522 associated with the service provider system 1502. In at least one example, the service provider system 1502 can credit the asset ledger 1524 of the user. Additionally, while the service provider system 1502 recognizes that the user retains the value of the transferred cryptocurrency through crediting the asset ledger 1524, an inspection of the blockchain will show the cryptocurrency as having been transferred to the service provider system 1502. In some examples, the asset wallet 1522 can be associated with many different addresses. In such examples, an inspection of the blockchain may not necessarily associate all cryptocurrency stored in asset wallet 1522 as belonging to the same entity. The presence of a private ledger used for real-time transactions and maintained by the service provider system 1502, combined with updates to the public ledger at other times, allows for extremely fast transactions using cryptocurrency to be achieved. In some examples, the “private ledger” can refer to the asset ledger 1524, which in some examples, can utilize the private blockchain 1532, as described herein. The “public ledger” can correspond to the public blockchain 1514 associated with the asset network.

In at least one example, an asset ledger 1524, fiat currency ledger 1526, or the like associated with the user account 1510 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1524. In some examples, a user can receive fiat currency or another currency in the form of payment for a transaction with another user. In at least one example, at least a portion of such funds can be converted into cryptocurrency by the service provider system 1502 and used to fund the asset ledger 1524 of the user.

In examples, a user can also have an account in U.S. dollars, which can be tracked, for example, via the fiat currency ledger 1526. Such an account can be funded by transferring money from a bank account at a third-party bank to an account maintained by the service provider system 1502 as is conventionally known. In some examples, a user can receive fiat currency in the form of payment for a transaction with another user. In such examples, at least a portion of such funds can be used to fund the fiat currency ledger 1526.

In some examples, a user can have one or more internal payment cards registered with the service provider system 1502. Internal payment cards can be linked to one or more of the accounts associated with the user account 1510. In some embodiments, options with respect to internal payment cards can be adjusted and managed using an application (e.g., the payment application 1426, a wallet application 1512, etc.).

In at least one example, the user account 1510 can be associated with the asset wallet accessible via a wallet application 1512 of the user device 1504, or a stored balance for use in payment transactions, peer-to-peer transactions, payroll payments, etc. In at least one example, the asset wallet 1522 can store data indicating an address provided for receipt of a cryptocurrency transaction. In at least one example, the balance of the asset wallet 1522 can be based at least in part on a balance of the asset ledger 1524. In at least one example, funds availed via the asset wallet 1522 can be stored in the asset wallet 1522. Funds availed via the asset wallet 1522 can be tracked via the asset ledger 1524. The asset wallet 1522, however, can be associated with additional cryptocurrency funds.

In at least one example, when the service provider system 1502 includes a private blockchain 1532 for recording and validating cryptocurrency transactions, the asset wallet 1522 can be used instead of, or in addition to, the asset ledger 1524. For example, a merchant can provide the address of the asset wallet 1522 for receiving payments. In an example where a customer is paying in cryptocurrency and the customer has their own cryptocurrency wallet account associated with the service provider system 1502, the customer can send a message signed by its private key including its wallet address (i.e., of the customer) and identifying the cryptocurrency and value to be transferred to the merchant's asset wallet 1522. The service provider system 1502 can complete the transaction by reducing the cryptocurrency balance in the customer's cryptocurrency wallet and increasing the cryptocurrency balance in the merchant's asset wallet 1522. In addition to recording the transaction in the respective cryptocurrency wallets, the transaction can be recorded in the private blockchain 1532 and the transaction can be confirmed. A user can perform a similar transaction with cryptocurrency in a peer-to-peer transaction as described above.

While the asset ledger 1524 and/or asset wallet 1522 are each described above with reference to cryptocurrency, the asset ledger 1524 and/or asset wallet 1522 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1502 is an aspect of the technology disclosed that enables technical advantages of increased processing speed and improved security.

The description of the environment 1500 above generally relates to a centralized service provider that at least partially facilitates storing and managing assets in the data store 1506. However, the environment 1500 may also facilitate decentralized storage and management of assets alternatively or in addition to centralized storage and management as described above. For instance, the environment 1500 may include a decentralized platform implemented using a plurality of nodes (e.g., web nodes), an example of which is illustrated as node 1516. The node 1516 is representative of a computer or other device tasked with validating transactions and/or maintaining a copy of a blockchain ledger, such as a ledger associated with the public blockchain 1514. The decentralized platform may be implemented via the environment 1500 through use of decentralized identifiers and verifiable credentials that are stored and managed by user devices 1504. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1502). The decentralized identity referenced by a decentralized identifier gives an entity control over what data can be accessed, stored, modified, and so forth by other entities, such as the service provider system 1502.

The node 1516, as representative of one of a plurality of decentralized nodes (e.g., decentralized web nodes), supports data storage and relays that allows entities, service provider systems, individuals, organizations and so forth to send, store, and receive encrypted or public messages and data. The node 1516 is universally addressable and is “crawlable” using data addressing in relation to the decentralized identifiers. The node 1516 is also configured to support decentralized replication of data across the nodes that is consistent across multiple nodes over time through continued data communication between the nodes in the decentralized platform. The node 1516 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1504 may be an issuer, a holder, and/or a verifier, as can the service provider system 1502.

In some examples, the user device 1504 may implement a wallet application 1512 configured to manage decentralized identifiers and/or verifiable credentials. For instance, the wallet application 1512 may provide a user interface for implementation of access controls to various data associated with the decentralized identifier by the service provider system 1502, to other user devices, and so forth. Additionally, the wallet application 1512 may be configured to provide functionality for resource transfers (e.g., cryptocurrency, fiat currency, etc.) with the service provider system 1502, other user devices, and the like, based on techniques described herein.

In some examples, the hardware wallet 1518 may store cryptocurrency assets in combination with the wallet application 1512 and the service provider system 1502. For instance, the hardware wallet 1518, the wallet application 1512, and the service provider system 1502 may each store a respective, different private key, where a transaction with the cryptocurrency assets is signed by at least two of the three private keys. The user interface provided by the wallet application 1512 may allow a user to request a transaction. The wallet application 1512 may then sign the transaction with the private key of the wallet application 1512, have either the hardware wallet 1518 or the service provider system 1502 use a second of the three private keys to sign the transaction, and then provide the transaction with two signatures to the public blockchain 1514 for processing.

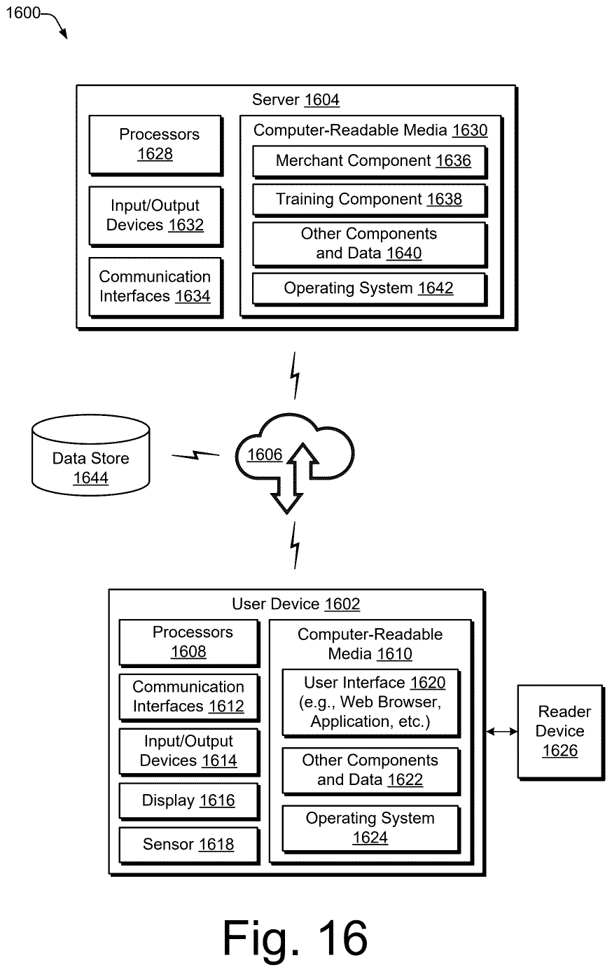

FIG. 16 depicts an illustrative block diagram illustrating a system 1600 for performing techniques described herein. The system 1600 includes a user device 1602, that communicates with server computing device(s) (e.g., server(s) 1604) via network(s) 1606 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1602 is illustrated, in additional or alternate examples, the system 1600 can have multiple user devices, as described above with reference to FIG. 14 and the client device 106 and consumer device of FIG. 1.

In at least one example, the user device 1602 can be any suitable type of computing device, e.g., portable, semi-portable, semi-stationary, or stationary. Some examples of the user device 1602 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 1602 can be any computing device capable of sending communications and performing the functions according to the techniques described herein. The user device 1602 can include devices, e.g., payment card readers, or components capable of accepting payments, as described below. The user device 1602 may be representative of, and provide functionality for, the user devices 1406 described in relation to FIG. 14.

In the illustrated example, the user device 1602 includes one or more processors 1608, one or more computer-readable media 1610, one or more communication interface(s) 1612, one or more input/output (I/O) devices 1614, a display 1616, and sensor(s) 1618. The user device 1602 is also configurable to include one or more encoders and one or more decoders.

In at least one example, each processor 1608 can itself comprise one or more processors or processing cores. For example, the processor(s) 1608 can be implemented as one or more microprocessors, microcomputers, microcontrollers, digital signal processors, central processing units, state machines, logic circuitries, and/or any devices that manipulate signals based on operational instructions. In some examples, the processor(s) 1608 can be one or more hardware processors and/or logic circuits of any suitable type specifically programmed or configured to execute the algorithms and processes described herein. The processor(s) 1608 can be configured to fetch and execute computer-readable processor-executable instructions stored in the computer-readable media 1610.

Depending on the configuration of the user device 1602, the computer-readable media 1610 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1610 can include, but is not limited to, RAM, ROM, EEPROM, flash memory, solid-state storage, magnetic disk storage, optical storage, and/or other computer-readable media technology. Further, in some examples, the user device 1602 can access external storage, such as RAID storage systems, storage arrays, network attached storage, storage area networks, cloud storage, or any other medium that can be used to store information and that can be accessed by the processor(s) 1608 directly or through another computing device or network. Accordingly, the computer-readable media 1610 can be computer storage media able to store instructions, components or components that can be executed by the processor(s) 1608. Further, when mentioned, non-transitory computer-readable media exclude media such as energy, carrier signals, electromagnetic waves, and signals per se.

The computer-readable media 1610 can be used to store and maintain any number of functional components that are executable by the processor(s) 1608. In some implementations, these functional components comprise instructions or programs that are executable by the processor(s) 1608 and that, when executed, implement operational logic for performing the actions and services attributed above to the user device 1602. Functional components stored in the computer-readable media 1610 can include a user interface 1620 to enable users to interact with the user device 1602, and thus the server(s) 1604 and/or other networked devices. In at least one example, a user can interact with the user interface via touch input, spoken input, gesture, or any other type of input, e.g., for the user interfaces of FIGS. 3, 5, and 7-12. The word “input” is also used to describe “contextual” input that may not be directly provided by the user via the user interface 1620. For example, user's interactions with the user interface 1620 are analyzed using, e.g., natural language processing techniques, user movement tracking techniques, eye tracking techniques, etc. to determine context or intent of the user, which may be treated in a manner similar to “direct” user input.

Depending on the type of the user device 1602, the computer-readable media 1610 can also optionally include other functional components and data, such as other components and data 1622, which can include programs, drivers, etc., and the data used or generated by the functional components. In addition, the computer-readable media 1610 can also store data, data structures and the like, that are used by the functional components. Further, the user device 1602 can include many other logical, programmatic and physical components, of which those described are merely examples that are related to the discussion herein.

In at least one example, the computer-readable media 1610 can include additional functional components, such as an operating system 1624 for controlling and managing various functions of the user device 1602 and for enabling user interactions.

The communication interface(s) 1612 can include one or more interfaces and hardware components for enabling communication with various other devices, such as over the network(s) 1606 or directly. For example, communication interface(s) 1612 can enable communication through one or more network(s) 1606, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1606 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1602 can further include one or more input/output (I/O) devices 1614. The I/O devices 1614 can include speakers, a microphone, a camera, and various user controls (e.g., buttons, a joystick, a keyboard, a keypad, etc.), a haptic output device, and so forth. The I/O devices 1614 can also include attachments that leverage the accessories (audio-jack, USB-C, Bluetooth, etc.) to connect with the user device 1602.

In at least one example, user device 1602 can include a display 1616. Depending on the type of computing device(s) used as the user device 1602, the display 1616 can employ any suitable display technology. For example, the display 1616 can be a liquid crystal display, a plasma display, a light emitting diode display, an OLED (organic light-emitting diode) display, an electronic paper display, or any other suitable type of display able to present digital content thereon. In at least one example, the display 1616 can be an augmented reality display, a virtual reality display, or any other display able to present and/or project digital content. In some examples, the display 1616 can have a touch sensor associated with the display 1616 to provide a touchscreen display configured to receive touch inputs for enabling interaction with a graphic interface presented on the display 1616. Accordingly, implementations herein are not limited to any particular display technology. In some examples, the user device 1602 may not include the display 1616, and information can be presented by other means, such as aurally, haptically, etc.

In addition, the user device 1602 can include sensor(s) 1618. The sensor(s) 1618 can include a global positioning system (“GPS”) device able to indicate location information. Further, the sensor(s) 1618 can include, but are not limited to, an accelerometer, gyroscope, compass, proximity sensor, camera, microphone, and/or a switch.

In some examples, the GPS device can be used to identify a location of a user. In at least one example, the location of the user can be used by the seller platform 1410, the P2P platform 1412, and/or the media content platform 1414, described above, to provide one or more services. That is, in some examples, the service provider can implement geofencing to provide particular services to users by the seller platform 1410, the P2P platform 1412, and/or the media content platform 1414.

In examples, the user device 1602 includes a codec system, which may comprise an encoder and/or a decoder. The encoder is configured to encode a data stream or signal from an analog signal (e.g., an analog audio signal, an analog video signal, etc.) to a digital signal for transmission or storage. The decoder is configured to convert the digital signal back to an analog signal, such as for playback or editing. In some cases, the encoder may be configured to encode the data stream or analog signal in an encrypted format, and the decoder may accordingly be configured to decrypt the digital signal as part of the decoding process (e.g., using a cryptographic key). Additionally, in some examples, the encoder may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder and/or the decoder may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 1600, the server 1604 may include an encoder and/or a decoder as well.

Additionally, the user device 1602 can include various other components that are not shown, examples of which include removable storage, a power source, such as a battery and power control unit, a barcode scanner, a printer, a cash drawer, and so forth.

In addition, as described in relation to FIG. 14, the user device 1602 can include, be connectable to, or otherwise be coupled to a reader device 1626, for reading payment instruments and/or identifiers associated with payment objects. The reader device 1626 can include a read head for reading a magnetic strip of a payment card, and further can include encryption technology for encrypting the information read from the magnetic strip. Additionally or alternatively, the reader device 1626 can be an EMV payment reader, which in some examples, can be embedded in the user device 1602. Moreover, numerous other types of readers can be employed with the user device 1602 herein, depending on the type and configuration of the user device 1602.

The reader device 1626 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 1626 may include hardware implementation, such as slots, magnetic tracks, and rails with one or more sensors or electrical contacts to facilitate detection and acceptance of a payment instrument. That is, the reader device 1626 may include hardware implementations to enable the reader device 1626 to interact with a payment instrument via a swipe, a dip, or a tap to obtain payment data associated with a customer. Additionally or optionally, the reader device 1626 may also include a biometric sensor to receive and process biometric characteristics and process them as payment instruments, given that such biometric characteristics are registered with the payment service and connected to a financial account with a bank server. The reader device 1626 may include processing unit(s), computer-readable media, a reader chip, a transaction chip, a timer, a clock, a network interface, a power supply, and so on. That is, the reader device 1626 may include any of the computing components described herein with reference to the user device 1602 to implement the functionality provided by the reader device 1626.

In examples, the reader device 1626 includes a reader chip, which may perform functionality to control the power supply, among other functionality of the reader device 1626. The power supply may include one or more power supplies such as a physical connection to AC power or a battery. Power supply may include power conversion circuitry for converting AC power and generating a plurality of DC voltages for use by components of reader device 1626. When power supply includes a battery, the battery may be charged via a physical power connection, via inductive charging, or via any other suitable method.

The reader device 1626 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1602, which can be a POS terminal, and the reader device 1626 are shown as separate devices, in additional or alternative examples, the user device 1602 and the reader device 1626 can be part of a single device, which may be a battery-operated device. In some examples, the reader device 1626 can have a display integrated therewith, which can be in addition to (or as an alternative of) the display 1616 associated with the user device 1602.

The server(s) 1604 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1604 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1604 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1604 can include one or more processors 1628, one or more computer-readable media 1630, one or more I/O devices 1632, and one or more communication interfaces 1634. Each processor 1628 can be a single processing unit or a number of processing units and can include single or multiple computing units or multiple processing cores. The processor(s) 1628 can be implemented as one or more microprocessors, microcomputers, microcontrollers, digital signal processors, central processing units, state machines, logic circuitries, and/or any devices that manipulate signals based on operational instructions. For example, the processor(s) 1628 can be one or more hardware processors and/or logic circuits of any suitable type specifically programmed or configured to execute the algorithms and processes described herein. The processor(s) 1628 can be configured to fetch and execute computer-readable instructions stored in the computer-readable media 1630, which can program the processor(s) 1628 to perform the functions described herein.

The computer-readable media 1630 can include volatile and nonvolatile memory and/or removable and non-removable media implemented in any type of technology for storage of information, such as computer-readable instructions, data structures, program components, or other data. Such computer-readable media 1630 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1604, the computer-readable media 1630 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1630 can be used to store any number of functional components that are executable by the processor(s) 1628. In many implementations, these functional components comprise instructions or programs that are executable by the processors 1628 and that, when executed, specifically configure the one or more processors 1628 to perform the actions attributed above to the seller platform 1410, the P2P platform 1412, and/or the media content platform 1414. Functional components stored in the computer-readable media 1630 can optionally include a merchant component 1636, a training component 1638, and one or more other components and data 1640. The computer-readable media 1630 can additionally include an operating system 1642 for controlling and managing various functions of the server(s) 1604.

The merchant component 1636 can be configured to receive transaction data from POS systems, such as the POS system 1424 described above with reference to FIG. 14. The merchant component 1636 can transmit requests (e.g., authorization, capture, settlement, etc.) to payment service server computing device(s) to facilitate POS transactions between merchants and customers. The merchant component 1636 can communicate the successes or failures of the POS transactions to the POS systems.

The training component 1638 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1602 and/or the server(s) 1604 for use at a time after the data models have been trained (e.g., at runtime).

The one or more other components and data 1640 can include functionality of which is described above. Further, the one or more other components and data 1640 can include programs, drivers, etc., and the data used or generated by the functional components. Further, the server(s) 1604 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 1634 can include one or more interfaces and hardware components for enabling communication with various other devices, such as over the network(s) 1606 or directly. For example, communication interface(s) 1634 can enable communication through one or more network(s) 1606, which can include, but are not limited any type of network known in the art, as described herein.

The server(s) 1604 can further be equipped with various I/O devices 1632. Such I/O devices 1632 can include a display, various user interface controls (e.g., buttons, joystick, keyboard, mouse, touch screen, biometric or sensory input devices, etc.), audio speakers, connection ports and so forth.

In at least one example, the system 1600 can include a datastore 1644 that can be configured to store data that is accessible, manageable, and updatable. In some examples, the datastore 1644 can be integrated with the user device 1602 and/or the server(s) 1604. In other examples, as shown in FIG. 16, the datastore 1644 can be located remotely from the server(s) 1604 and can be accessible to the server(s) 1604. The datastore 1644 can comprise multiple databases and/or servers connected locally and/or remotely via the network(s) 1606. In at least one example, the datastore 1644 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 1644 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1644 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
associating computer-executable code configured to dynamically render user interface elements of an item creation workflow with a computing device of a merchant;
displaying, utilizing the computer-executable code, an item designation user interface element via a user interface of the computing device, the item designation user interface element displayed in association with the item creation workflow;
receiving first user input data indicating interaction with the item designation user interface element;
dynamically filtering the user interface elements based on a relevance to the first user input data to generate a filtered set of user interface elements of the item creation workflow;
causing, utilizing the computer-executable code, the filtered set of user interface elements from the item creation workflow to be presented in the user interface;
receiving second user input data indicating information to be associated with an item in a digital catalog; and
generating an item entry based on the item designation and the information associated with the item in the digital catalog.

2. The method as described in claim 1, wherein the first user input data includes an uploaded digital image and analyzing the digital image using a machine-learning model to automatically suggest at least one of an item name, item type, a category, or variant attributes.

3. The method as described in claim 1, further comprising modifying a layout of the item creation interface based on historical behavior indicating frequent or infrequency use of particular interface elements.

4. The method as described in claim 1, wherein the dynamically filtering includes:
generating an item prompt that includes instructions for processing by a language model to identify a plurality of item descriptions, the item prompt referencing the digital catalog; and
inferring the plurality of item descriptions from the language model.

5. The method as described in claim 1, further comprising:
generating a catalog schema for a designated item type from a plurality of item descriptions in a digital catalog, the catalog schema specifying content arrangement and respective user interface elements from respective item descriptions;
forming a catalog module that is executable to implement the catalog schema and the respective user interface elements to implement the user interface; and
generating a modular catalog architecture by aggregating a plurality of said catalog modules, the modular catalog architecture configured to execute respective said catalog modules responsive to a determination of a type of item description from an input based on the catalog schema to create an item description.

6. A method comprising:
receiving, by a computing device, a request to create an item in a digital catalog;
displaying, on a display device of the computing device, an initial item creation interface including at least one field for designating an item type;
receiving, via the initial item creation interface, a user input designating an item type for the item;
retrieving, from a database, a catalog schema associated with the designated item type, the schema defining a set of attributes relevant to the designated item type;
dynamically rendering a customized item creation interface based on the retrieved catalog schema, the customized item creation interface including:
a plurality of input fields corresponding to the set of attributes defined by the catalog schema, and
one or more user interface elements for specifying channels for the item;
displaying the customized item creation interface on the display;
receiving, via the customized item creation interface, user input specifying values for one or more of the plurality of input fields and selecting one or more channels;
in response to receiving user input selecting a respective said channel, dynamically updating the customized item creation interface to display at least one additional input field based on the selected channel;
generating an item entry in the digital catalog based on the received user input; and
persisting the generated item entry in association with the digital catalog.

7. The method as described in claim 6, further comprising selecting a catalog module from a plurality of catalog modules of a modular catalog architecture based on the item type, the selected catalog module associated with a set of interface elements and thereby filtering out one or more interface elements associated with another catalog module of the plurality of catalog modules that are unrelated to an inferred item type.

8. The method as described in claim 7, wherein the selected catalog module that is executable to implement the catalog schema and the customized item creation interface.

9. The method as described in claim 6, further comprising:
generating the catalog schema for the designated item type from a plurality of item descriptions in the digital catalog, the catalog schema specifying content arrangement and respective said user interface elements from respective said item descriptions;
forming a catalog module that is executable to implement the catalog schema and the respective said user interface elements to implement the customized item creation interface; and
generating a modular catalog architecture by aggregating a plurality of said catalog modules, the modular catalog architecture configured to execute respective said catalog modules responsive to a determination of a type of item description from an input based on the catalog schema to create an item description.

10. The method as described in claim 9, wherein the forming is performed using a machine-learning model.

11. The method as described in claim 10, wherein the machine-learning model is a language model that generates executable code of the catalog module as part of the forming.

12. The method as described in claim 6, wherein the receiving, via the customized item creation interface, the user input includes an uploaded digital image and analyzing the digital image using a machine-learning model to automatically suggest at least one of an item name, item type, or variant attributes.

13. The method as described in claim 6, further comprising modifying a layout of the item creation interface based on historical behavior indicating frequent or infrequency use of particular interface elements.

14. A computer-implemented method comprising:
identifying a plurality of item descriptions from a digital catalog;
determining one or more user interface elements associated with the plurality item descriptions, respectively;
generating a catalog schema for each item type from the plurality of item descriptions, the catalog schema specifying content arrangement and respective said user interface elements for respective said item descriptions;
forming a catalog module that is executable to implement the catalog schema and the respective said user interface elements; and
generating a modular catalog architecture by aggregating a plurality of said catalog modules, the modular catalog architecture configured to execute respective said catalog modules responsive to a determination of a type of item description from an input based on the catalog schema to create an item description.

15. The method as described in claim 14, wherein the plurality of item descriptions include physical and digital products or services.

16. The method as described in claim 14, further comprising outputting a verification user interface configured to verify the modular catalog architecture.

17. The method as described in claim 14, wherein the identifying includes:
generating an item prompt that includes instructions for processing by a language model to identify the plurality of item descriptions, the item prompt referencing the digital catalog; and
inferring the plurality of item descriptions from the language model.

18. The method as described in claim 14, wherein the determining includes:
generating a user interface element prompt for processing by a language model that includes instruction to identify the one or more user interface elements, the user interface element prompt referencing the digital catalog; and
receiving the one or more user interface elements from the language model.

19. The method as described in claim 14, wherein the generating the catalog schema includes:
generating a catalog schema prompt for processing by a language model that includes instructions to generate the catalog schema, the catalog schema prompt including one or more of the plurality of item descriptions and the one or more user interface elements; and
receiving the catalog schema from the language model.

20. The method as described in claim 14, wherein the forming includes:
generating an executable prompt that includes instructions for processing by a language model to generate a catalog module that is executable to generate a type of item description, the executable prompt referencing the one or more user interface elements, a respective said item description, and the catalog schema; and
receiving the language model having executable code from the language model.
